(19) United States
(12) Patent Application Publication
(10) Pub. No.: US 2017/0346596 A1
(43) Pub. Date: Nov. 30, 2017

(54) METHOD, APPARATUS, AND SYSTEM FOR SIGNAL EQUALIZATION

(71) Applicant: Intel Corporation, Santa Clara, CA (US)

(72) Inventors: Nathaniel L. Desimone, Portland, OR (US); Theodore Zale Schoenborn, Portland, OR (US); Earl Jeffrey Wight, Beaverton, OR (US); Bryan Spry, Portland, OR (US); Jorge Garcia Forteza, Hillsboro, OR (US); Sean Robert Graham, Hillsboro, OR (US); Duane Heller, Portland, OR (US)

(73) Assignee: Intel Corporation, Santa Clara, CA (US)

(21) Appl. No.: 15/166,871

(22) Filed: May 27, 2016

(51) Int. Cl. H04L 1/00; G06F 11/30; G06F 13/42; H04L 12/26

(52) U.S. Cl. CPC H04L 1/0034; H04L 43/087; G06F 11/3051; G06F 11/3062; G06F 13/4282

(57) ABSTRACT

Aspects of the embodiments are directed to systems, methods, and apparatuses to determine transmission equalization coefficients (TxEQs) for one or more lanes of a high speed serial link. Embodiments include determining a jitter tolerance for each TxEQ of a plurality of TxEQs for a lane of the link. The jitter tolerance for each TxEQ for the lane is based on a level of jitter induced on the lane to detect a number of errors on the lane; determining a voltage (VOC) margin for each TxEQ for the lane, wherein the voltage margin for the lane is based on a voltage corners test applied to the lane to detect a number of errors on the lane at a high voltage point and a low voltage point; determining a TxEQ that provides maximum jitter tolerance and based on the determined lowest voltage margin; and using the TxEQ for the lane during operation.

### FIELD

This disclosure pertains to computing systems, and in particular (but not exclusively) to techniques for maximizing performance of a communication link.

### BACKGROUND

High speed busses in computer systems can experience some signal loss when data is transmitted between a transmitting circuit element and a receiving circuit element. For example, signal reflections can be caused by impedance mismatches and discontinuities (such as vias or connectors) in the channel carrying the data signal. The skin effect is another source of channel loss. In order to maintain a high signal to noise ratio, equalization can be used. Equalization involves distorting the data signal using a transfer function which represents the approximate inverse of the channel response. This distortion should effectively cancel signal loss that occurs within the channel.

In PCIe 2.x, an approximate equalization to compensate for channel loss was introduced called Tx de-emphasis. Tx de-emphasis was based on the theory that all PCIe channels will exhibit greater loss at high frequencies. Tx de-emphasis involves sending data at full swing after each polarity transition in the data signal, after which the swing is reduced for all bits in the data signal of the same polarity. The goal of this is to reduce the energy of low frequency content that is transferred with the data signal to compensate for the increased channel loss at high frequencies.

### BRIEF DESCRIPTION OF THE DRAWINGS

FIG. 1 illustrates an embodiment of a block diagram for a computing system including a multicore processor.

FIG. 2 illustrates an embodiment of a computing system including an interconnect architecture.

FIG. 3 illustrates an embodiment of a interconnect architecture including a layered stack.

FIG. 4 illustrates an embodiment of a request or packet to be generated or received within an interconnect architecture.

FIG. 5 illustrates an embodiment of a transmitter and receiver pair for an interconnect architecture.

FIG. 6 is a process flow diagram for signal equalization in accordance with embodiments of the present disclosure.

FIG. 7 is a process flow diagram for performing link health experimentation in accordance with embodiments of the present disclosure.

FIG. 8 is a process flow diagram for performing link jitter testing in accordance with embodiments of the present disclosure.

FIG. 9A is a process flow diagram for performing a point test in accordance with embodiments of the present disclosure.

FIG. 9B is a graphical illustration representing dwell times and error rates for the point test subroutine in accordance with embodiments of the present disclosure.

FIG. 10 is a process flow diagram for interpolating errors to determine a score in a jitter test in accordance with embodiments of the present disclosure.

FIG. 11 is a process flow diagram for calculating a difference in a jitter test in accordance with embodiments of the present disclosure.

FIG. 12A is a process flow diagram for performing a voltage (VOC) corners test in accordance with embodiments of the present disclosure.

FIG. 12B is a graphical illustration representing dwell times and error rates for the voltage (VOC) test in accordance with embodiments of the present disclosure.

FIG. 13 is a schematic block diagram of an embodiment of a multicore processor in accordance with embodiments of the present disclosure.

FIG. 14 illustrates an embodiment of a block diagram for a processor in accordance with embodiments of the present disclosure.

FIG. 15 illustrates another embodiment of a block diagram for a computing system including a processor.

FIG. 16 illustrates an embodiment of a block for a computing system including multiple processor sockets in accordance with embodiments of the present disclosure.

FIG. 17 illustrates another embodiment of a block diagram for a computing system in accordance with embodiments of the present disclosure.

FIG. 18 illustrates another embodiment of a block diagram for a computing system in accordance with embodiments of the present disclosure.

FIG. 19 is a process flow diagram for identifying transmission equalization coefficients for transmission across one or more lanes of a communications bus in accordance with embodiments of the present disclosure.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

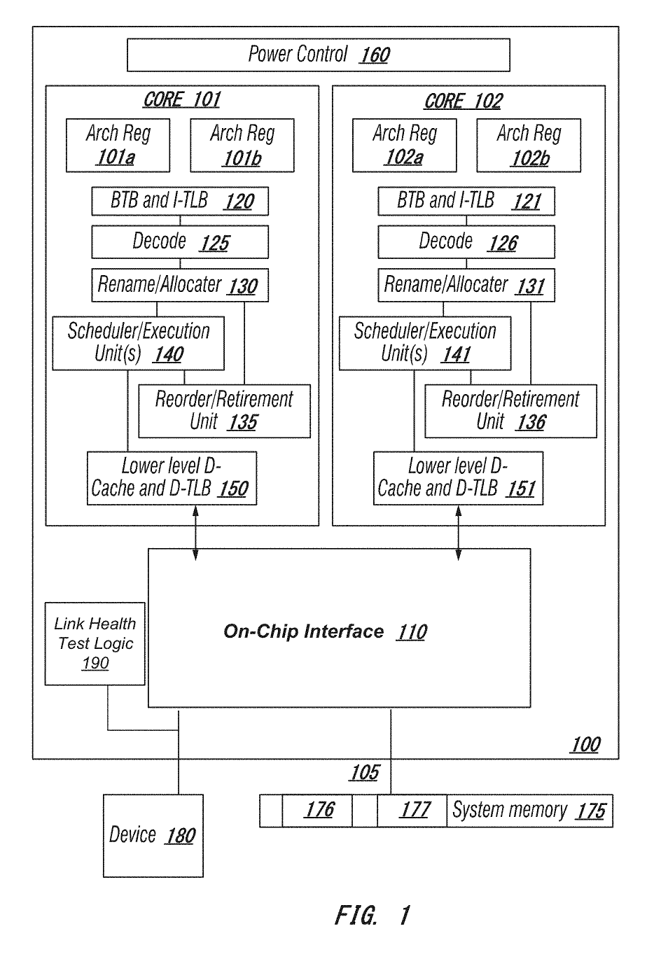

FIG. 1 illustrates an embodiment of a block diagram for a computing system including a multicore processor. Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as reorder buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

In some embodiments, processor 100 may include link health logic circuitry 190. Link health logic circuitry 190 may include logic circuitry to apply a transmission equalization coefficient to a lane of a communications link, such as to the communications link connecting processor 100 to device 180 Link health logic circuitry 190 may also include jitter logic circuitry to perform a jitter tolerance test on the lane of a communications link using the transmission equalization coefficient. Link health logic circuitry 190 may also include voltage logic circuitry to perform a voltage test on the lane of the communications link transmission equalization coefficient. Link health logic circuitry 190 may include logic circuitry to determine a best equalization coefficient for the lane based on the jitter tolerance test and based on the voltage test. Link health logic circuitry 190 logic circuitry to provide the best equalization coefficient for the lane to a transmitting circuit element

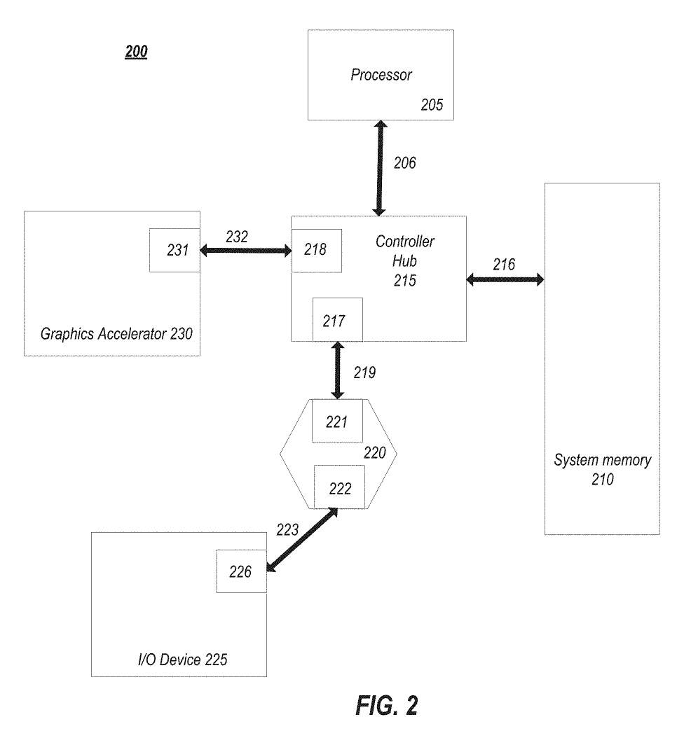

Referring to FIG. 2, an embodiment of a fabric composed of point-to-point Links that interconnect a set of components is illustrated. System 200 includes processor 205 and system memory 210 coupled to controller hub 215. Processor 205 includes any processing element, such as a microprocessor, a host processor, an embedded processor, a co-processor, or other processor. Processor 205 is coupled to controller hub 215 through front-side bus (FSB) 206. In one embodiment, FSB 206 is a serial point-to-point interconnect as described below. In another embodiment, link 206 includes a serial, differential interconnect architecture that is compliant with different interconnect standard.

System memory 210 includes any memory device, such as random access memory (RAM), non-volatile (NV) memory, or other memory accessible by devices in system 200. System memory 210 is coupled to controller hub 215 through memory interface 216. Examples of a memory interface include a double-data rate (DDR) memory interface, a dual-channel DDR memory interface, and a dynamic RAM (DRAM) memory interface.

In one embodiment, controller hub 215 is a root hub, root complex, or root controller in a Peripheral Component Interconnect Express (PCIe or PCIE) interconnection hierarchy. Examples of controller hub 215 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 205, while controller 215 is to communicate with I/O devices, in a similar manner as described below. In some embodiments, peer-to-peer routing is optionally supported through root complex 215.

Here, controller hub 215 is coupled to switch/bridge 220 through serial link 219. Input/output modules 217 and 221, which may also be referred to as interfaces/ports 217 and 221, include/implement a layered protocol stack to provide communication between controller hub 215 and switch 220. In one embodiment, multiple devices are capable of being coupled to switch 220.

Switch/bridge 220 routes packets/messages from device 225 upstream, i.e. up a hierarchy towards a root complex, to controller hub 215 and downstream, i.e. down a hierarchy away from a root controller, from processor 205 or system memory 210 to device 225. Switch 220, in one embodiment, is referred to as a logical assembly of multiple virtual PCI-to-PCI bridge devices. Device 225 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 225 may include a PCIe to PCI/PCI-X bridge to support legacy or other version PCI devices. Endpoint devices in PCIe are often classified as legacy, PCIe, or root complex integrated endpoints.

Graphics accelerator 230 is also coupled to controller hub 215 through serial link 232. In one embodiment, graphics accelerator 230 is coupled to an MCH, which is coupled to an ICH. Switch 220, and accordingly I/O device 225, is then coupled to the ICH. I/O modules 231 and 218 are also to implement a layered protocol stack to communicate between graphics accelerator 230 and controller hub 215. Similar to the MCH discussion above, a graphics controller or the graphics accelerator 230 itself may be integrated in processor 205.

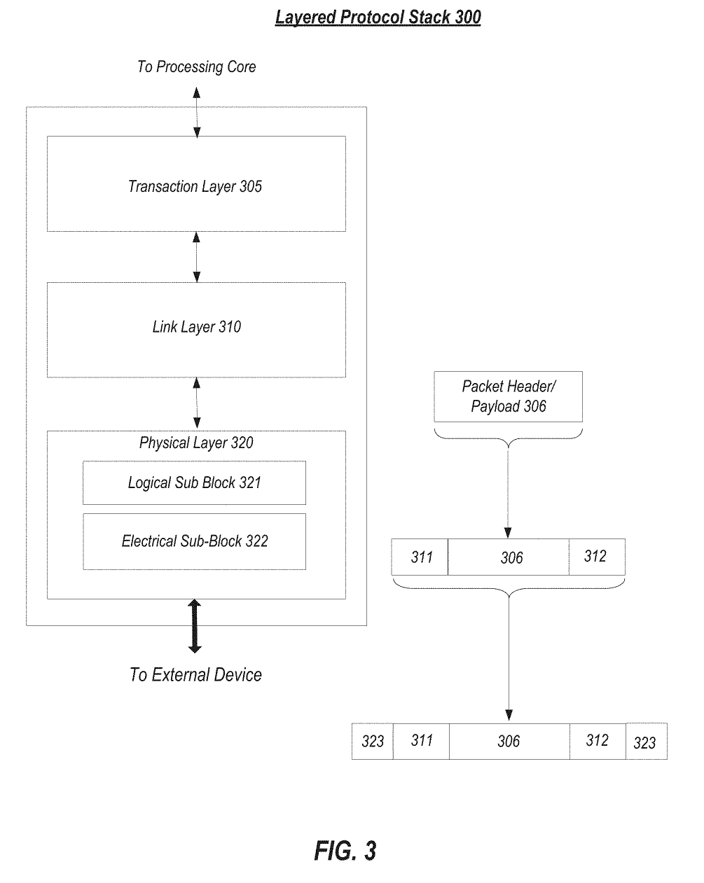

Turning to FIG. 3 an embodiment of a layered protocol stack is illustrated. Layered protocol stack 300 includes any form of a layered communication stack, such as a Quick Path Interconnect (QPI) stack, a PCie stack, a next generation high performance computing interconnect stack, or other layered stack. Although the discussion immediately below in reference to FIGS. 2-5 are in relation to a PCIe stack, the same concepts may be applied to other interconnect stacks. In one embodiment, protocol stack 300 is a PCIe protocol stack including transaction layer 305, link layer 310, and physical layer 320. An interface, such as interfaces 217, 218, 221, 222, 226, and 231 in FIG. 2, may be represented as communication protocol stack 300. Representation as a communication protocol stack may also be referred to as a module or interface implementing/including a protocol stack.

PCI Express uses packets to communicate information between components. Packets are formed in the Transaction Layer 305 and Data Link Layer 310 to carry the information from the transmitting component to the receiving component. As the transmitted packets flow through the other layers, they are extended with additional information necessary to handle packets at those layers. At the receiving side the reverse process occurs and packets get transformed from their Physical Layer 320 representation to the Data Link Layer 310 representation and finally (for Transaction Layer Packets) to the form that can be processed by the Transaction Layer 305 of the receiving device.

Transaction Layer

In one embodiment, transaction layer 305 is to provide an interface between a device's processing core and the interconnect architecture, such as data link layer 310 and physical layer 320. In this regard, a primary responsibility of the transaction layer 305 is the assembly and disassembly of packets (i.e., transaction layer packets, or TLPs). The translation layer 305 typically manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 305. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 305 assembles packet header/payload 306. Format for current packet headers/payloads may be found in the PCIe specification at the PCIe specification website.

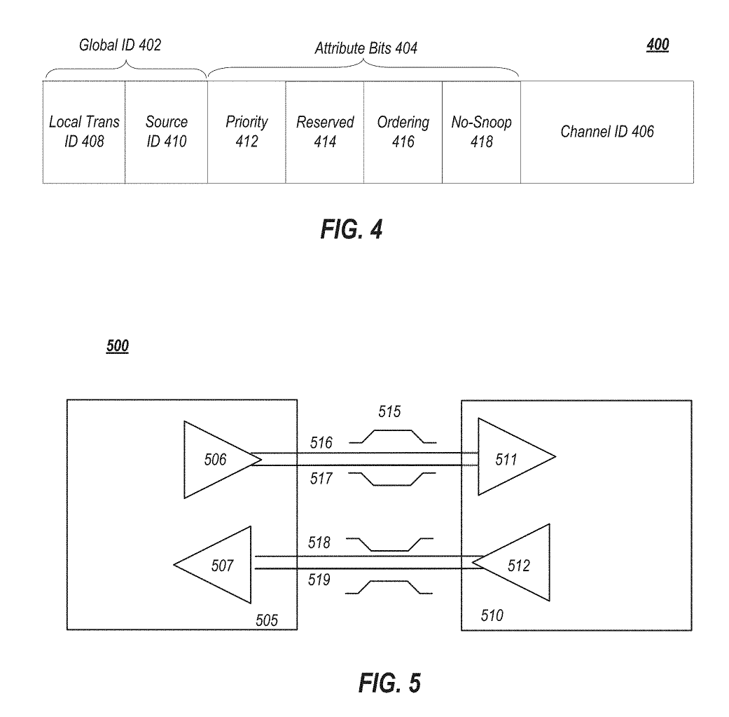

Quickly referring to FIG. 4, an embodiment of a PCIe transaction descriptor is illustrated. In one embodiment, transaction descriptor 400 is a mechanism for carrying transaction information. In this regard, transaction descriptor 400 supports identification of transactions in a system. Other potential uses include tracking modifications of default transaction ordering and association of transaction with channels.

Transaction descriptor 400 includes global identifier field 402, attributes field 404 and channel identifier field 406. In the illustrated example, global identifier field 402 is depicted comprising local transaction identifier field 408 and source identifier field 410. In one embodiment, global transaction identifier 402 is unique for all outstanding requests.

According to one implementation, local transaction identifier field 408 is a field generated by a requesting agent, and it is unique for all outstanding requests that require a completion for that requesting agent. Furthermore, in this example, source identifier 410 uniquely identifies the requestor agent within a PCIe hierarchy. Accordingly, together with source ID 410, local transaction identifier 408 field provides global identification of a transaction within a hierarchy domain.

Attributes field 404 specifies characteristics and relationships of the transaction. In this regard, attributes field 404 is potentially used to provide additional information that allows modification of the default handling of transactions. In one embodiment, attributes field 404 includes priority field 412, reserved field 414, ordering field 416, and no-snoop field 418. Here, priority sub-field 412 may be modified by an initiator to assign a priority to the transaction. Reserved attribute field 414 is left reserved for future, or vendor-defined usage. Possible usage models using priority or security attributes may be implemented using the reserved attribute field.

In this example, ordering attribute field 416 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 418 is utilized to determine if transactions are snooped. As shown, channel ID Field 406 identifies a channel that a transaction is associated with.

Link Layer

Link layer 310, also referred to as data link layer 310, acts as an intermediate stage between transaction layer 305 and the physical layer 320. In one embodiment, a responsibility of the data link layer 310 is providing a reliable mechanism for exchanging Transaction Layer Packets (TLPs) between two components a link. One side of the Data Link Layer 310 accepts TLPs assembled by the Transaction Layer 305, applies packet sequence identifier 311, i.e. an identification number or packet number, calculates and applies an error detection code, i.e. CRC 312, and submits the modified TLPs to the Physical Layer 320 for transmission across a physical to an external device.

Physical Layer

In one embodiment, physical layer 320 includes logical sub block 321 and electrical sub-block 322 to physically transmit a packet to an external device. Here, logical sub-block 321 is responsible for the “digital” functions of Physical Layer 321. In this regard, the logical sub-block includes a transmit section to prepare outgoing information for transmission by physical sub-block 322, and a receiver section to identify and prepare received information before passing it to the Link Layer 310.

Physical block 322 includes a transmitter and a receiver. The transmitter is supplied by logical sub-block 321 with symbols, which the transmitter serializes and transmits onto to an external device. The receiver is supplied with serialized symbols from an external device and transforms the received signals into a bit-stream. The bit-stream is de-serialized and supplied to logical sub-block 321. In one embodiment, an 8b/10b transmission code is employed, where ten-bit symbols are transmitted/received. Here, special symbols are used to frame a packet with frames 323. In addition, in one example, the receiver also provides a symbol clock recovered from the incoming serial stream.

As stated above, although transaction layer 305, link layer 310, and physical layer 320 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 5, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 506/511 and a receive pair 512/507. Accordingly, device 505 includes transmission logic 506 to transmit data to device 510 and receiving logic 507 to receive data from device 510. In other words, two transmitting paths, i.e. paths 516 and 517, and two receiving paths, i.e. paths 518 and 519, are included in a PCIe link.

A transmission path refers to any path for transmitting data, such as a transmission line, a copper line, an optical line, a wireless communication channel, an infrared communication link, or other communication path. A connection between two devices, such as device 505 and device 510, is referred to as a link, such as link 415. A link may support one lane—each lane representing a set of differential signal pairs (one pair for transmission, one pair for reception). To scale bandwidth, a link may aggregate multiple lanes denoted by ×N, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

Note that the apparatus', methods', and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

Starting with PCIe 3.0, link speeds became high enough that Tx de-emphasis alone was no longer sufficient. PCIe 3.0 adds Tx pre-shoot to the equalization approximation in combination with Tx de-emphasis. Pre-shoot provides a slight increase in swing just before the polarity transition.

De-emphasis and pre-shoot settings are selected to optimize link performance. Each combination of transmitter, receiver, and channel will have its own set of optimal de-emphasis and pre-shoot settings. During link initialization, a training sequence is required to select the optimal settings. De-emphasis and pre-shoot combined are often referred to as Tx equalization tap coefficients.

A voltage test can be used in addition to a jitter tolerance test to mitigation effects resulting from high frequency and high-speed interconnects. Accurately measuring voltage margin could involve an order of magnitude increase in time compared to measuring jitter tolerance. This disclosure describes optimizing both a jitter tolerance and voltage margin test to address the potential timing needs.

This disclosure describes loops over all TxEQ coefficients to be considered as potential candidates and runs the link health experiment at each coefficient. After all experiments are complete, the algorithm selects the coefficients that yield the best link health.

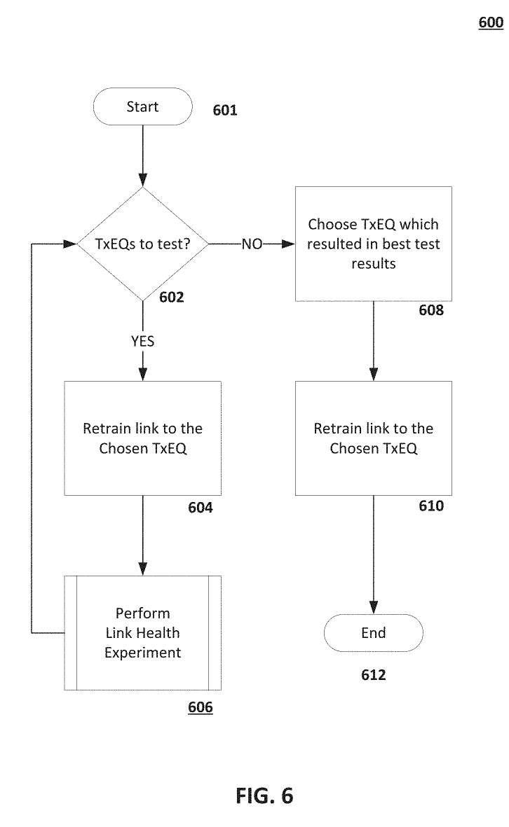

FIG. 6 is a diagram illustrating an algorithm loop 600 for performing a link health experiment. The link health experiment may include testing various equalization coefficients (TxEQs) to determine which coefficient yields the greatest jitter tolerance for each lane. As shown in the figure, the first health experiment procedure begins with block 601 (START) and proceeds along path to block 602—“More equalization coefficients (e.g., TxEQs) to Test?”.

At block 602, the link health experiment procedure makes a determination to whether there are any remaining TxEQs to apply to a lane of a communication link (or “link”) when testing the jitter tolerance of the link. For example, if three TxEQs are to be tested, and less than three TxEQs have been tested, the algorithm 600 will proceed to block 604 to test the next untested TxEQ.

One having ordinary skill in the art may appreciate that any number of equalization coefficients may be tested. As such, the present disclosure is not limited to testing only three TxEQs, as described in the previous embodiment, but may include testing more or less than three equalization coefficients which is in the spirit and scope of the present disclosure. For instance, 1, 5, or 10 equalization coefficients may be tested. It should be further understood by one having ordinary skill in the art that the time period for the link health experiment procedure may be a factor when choosing the number of equalization coefficients to test.

Block 604 provides “Retrain link to the chosen TxEQ” followed by block 606, which implements a subroutine: “Perform Link Health Experiment,” as will be described in more detail below.

If no other equalization coefficients are to be tested, the link health experiment procedure proceeds to block 608. As shown, block 608 provides “choos[ing] the equalization coefficient which yielded the best performance results.” As will be explained in more detail, the TxEQs which yielded the best results are the particular equalization coefficients per lane which the lane performed with the highest degree of induced jitter and pre-shoot (e.g., voltage test) before failing. In one embodiment, failing may be characterized as an inability to maintain a bit error rate threshold (e.g. 10̂−12) across the lane and/or number of errors above a threshold value at high and low test voltage values according to a communication protocol (e.g., PCIe).

Next, block 610 provides that the link is retrained to adopt the TxEQ which yielded the best performance results (e.g. greatest tolerance to jitter) for the respective tested lane. In one embodiment of the present disclosure, the link is retrained according to a specific protocol. For example, a PCIe link may be retrained according to a PCIe 3.0 equalization protocol. Accordingly, after the last TxEQ is tested, the link health experiment procedure ends (612).

The phase modulator can generate on the order of 24 steps of jitter stimulus. Jitter tolerance is evaluated by seeing how many increments of jitter can be added before errors occur on the link. Thirty (30) steps were added to this margin measurement for all TxEQ coefficient settings that pass the voltage margin minimum. In this way, the best TxEQ coefficient can be selected by comparing jitter tolerance results, and guarantee that the selected coefficient satisfies the minimum voltage margin requirement. Also, the opposite problem of a TxEQ with slightly better voltage margin but very poor jitter tolerance can be avoided by adding a check for at least 4 steps of jitter tolerance before the +30 credit to be added for passing the voltage test.

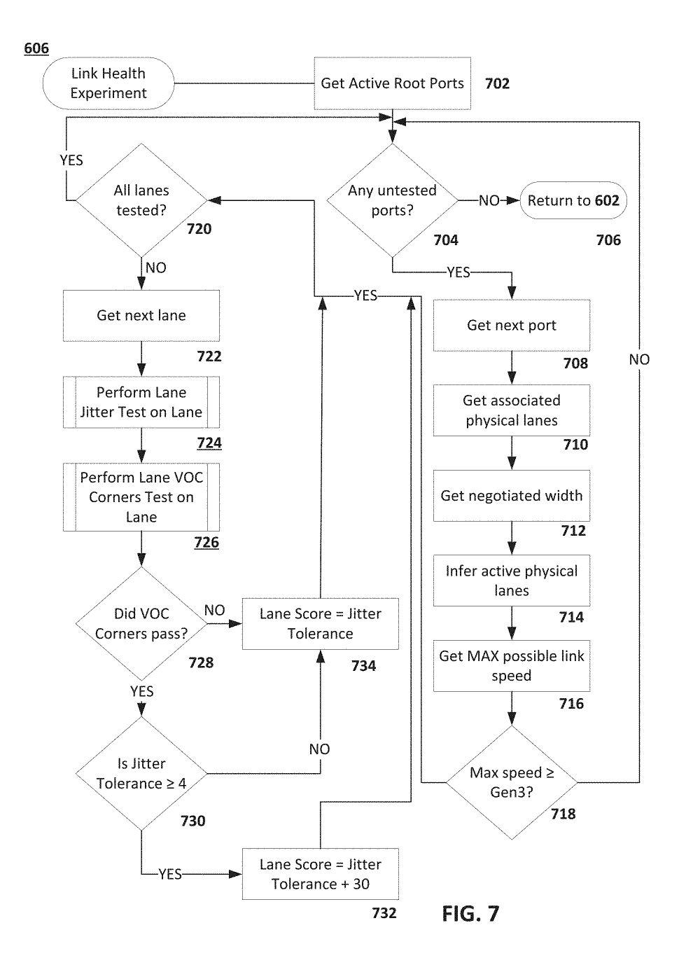

FIG. 7 is a diagram illustrating an algorithm loop for performing a link health experiment algorithm 606 for a communications link. The link health experiment 606 begins with block 702—“Get Active Root Ports.” In some embodiments, a root port, also referred to as a root complex port, may spawn a communication link hierarchy (e.g., PCIe hierarchy). In particular, a root complex device may have more than one root port each having a distinct hierarchy domain. For example, a root complex device may have two or more root ports coupled to two or more PCIe nodes.

In time, the link health experiment 606 proceeds to block 704: “Any untested root ports left?” If there are no other root ports to test, the link health experiment 606 proceeds to RETURN block 706. RETURN block 704 directs control back to block 602 of the algorithm loop 600 referred to in FIG. 6.

If there are any root ports that are untested, the link health experiment 608 moves to block 708—“Get Next Port” and then to block 710, “[g]etting associated physical lanes.” One having ordinary skill in the art may appreciate that a link coupled between ports (e.g., between a root complex device and an endpoint device) may have a plurality of lanes. For example, PCI Express 3.0 slots may contain from 1 to 32 lanes, in powers of two (1, 2, 4, 8, 16, and 32).

Further, according to block 712—“[g]et negotiated width.” In some embodiments, during initialization, each PCIe link may set up following a negotiation of link widths and frequency of operation by the two agents (e.g., PCIe devices) at each end of the link. In one embodiment, PCIe utilizes a broadcast technique for two link partners to perform lane negotiation. For instance, PCIe may utilize training sets to negotiate lane width and ordering.

Further, “[i]nfer active physical lanes” according to block 714. Further, block 716 provides—“[g]et maximum possible link speed.” For example, PCIe 3.0 provides a maximum possible link speed of 8 GT/s (e.g., Gen3 Speed). If the MAX Speed≧Gen3 Speed (block 718), the link health experiment 606 proceeds to block 720—“Have all lanes been tested?” If all lanes have been tested, the procedure 606 returns to block 704.

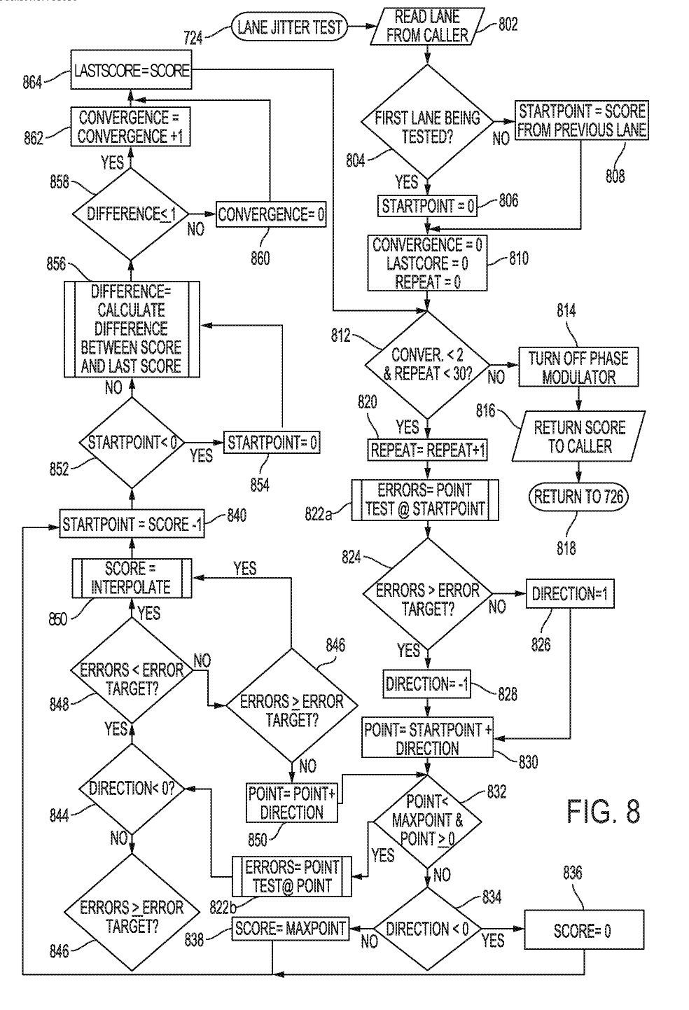

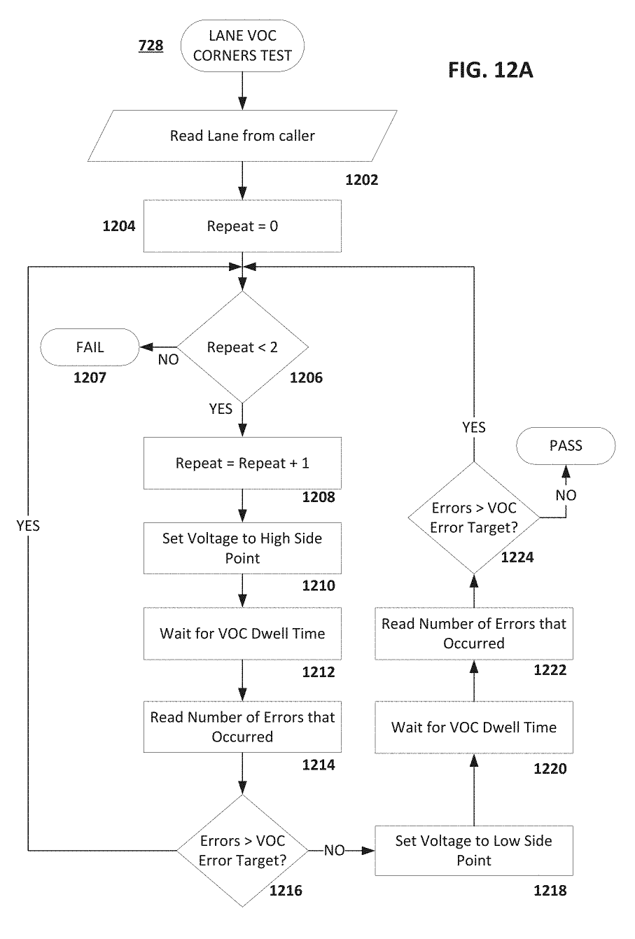

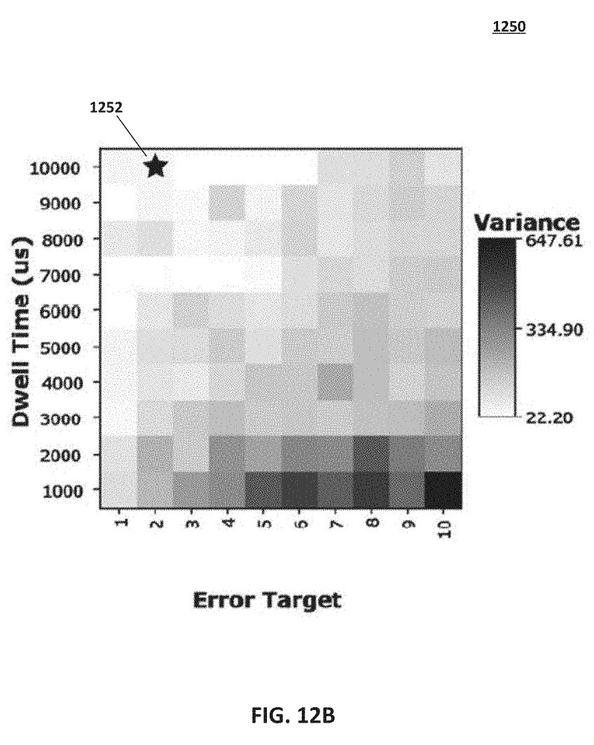

If all lanes have not been tested, the link health experiment procedure 606 proceeds to block 722—“Get Next Lane.” For example, if a link has 16 lanes and lane 0 was previously tested, lane 1 may be jitter tested next according to jitter test subroutine 724 as shown in the figure. The link health experiment 606 can then perform a voltage on the corners (VOC) test subroutine on the lane (726). In some embodiments, the link health experiment procedure 606 iterates through the lane test loop (blocks 720-726) until each lane of the link has been tested. A lane jitter test procedure will be described in more detail below in reference to FIG. 8. The VOC test subroutine is described in more detail in FIG. 12.

In the event that the conditional statement at block 718 is NOT TRUE, the link health experiment procedure 606 returns back to block 704. If no other ports remain for testing, block 704 returns to block 602 of the equalization procedure 600 shown in FIG. 6.

FIG. 8 is a diagram illustrating an algorithm loop 800 for a lane jitter test procedure 801 for each lane of a communication link. In one embodiment, algorithm loop 800 may be implemented as a function. Block 724 of algorithm 606 may be referred to as the caller which provides the lane to be tested. In one embodiment, lane jitter test 724 assigns and stores a score to each lane of a link for a particular TxEQ.

The lane jitter test procedure 724 begins along with block 802—“Read Lane from Caller.” Once the lane is read from the caller, lane jitter test procedure 724 proceeds to block 804—“First Lane being tested?” If the first lane (e.g., lane 0) is being tested, the lane jitter test procedure proceeds to block 806 and sets the value of the variable StartPoint to 0 as illustrated in the figure.

In the event that any lane other than the first lane is read from the caller, the variable StartPoint is assigned the score assigned to the previous lane in accordance with block 808. The value assigned to StartPoint is propagated throughout lane jitter test procedure 724 and applied accordingly as described herein. If the first lane is being tested, the values of StartPoint, Convergence, LastScore, and Repeat variables are all set to 0 (blocks 806, 808).

In addition, if the first lane is not being tested, the LastScore and Convergence and Repeat variables are assigned value=0 according to block 808 and 810. The variables LastScore and Convergence are initially given the value of 0 by block 808 regardless of whether the first lane is being tested or not. Next, lane jitter test procedure 724 proceeds to block 812 which provides a conditional branch to test whether Convergence is less than 2 and Repeat less than 30. In embodiments, Convergence represents the number of iterations that the lane jitter test procedure 724 returns the same score, per equalization coefficient, for the tested lane whereas Repeat represents the number of iterations the lane jitter test is performed for the tested lane.

A lane may be tested a maximum number of iterations to prevent the lane jitter test from iterating an infinite number of times. For example, each lane may be tested a maximum of 30 iterations.

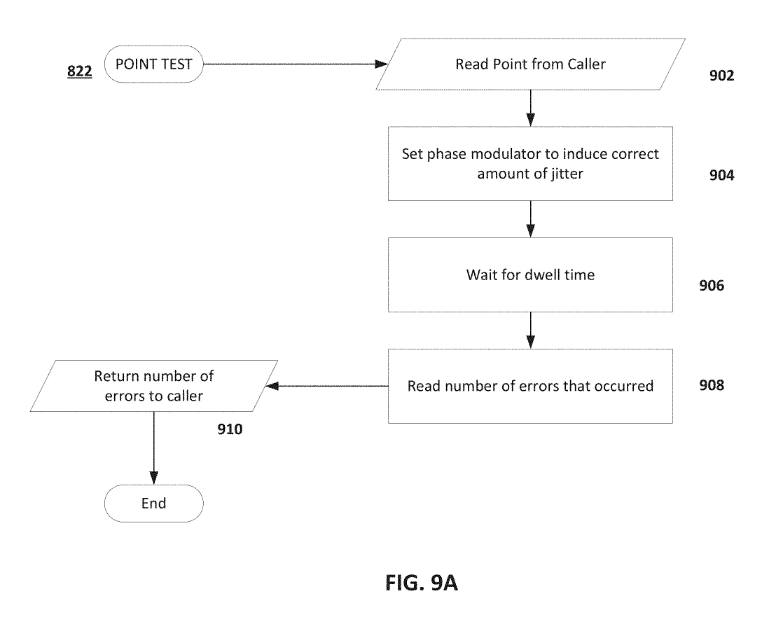

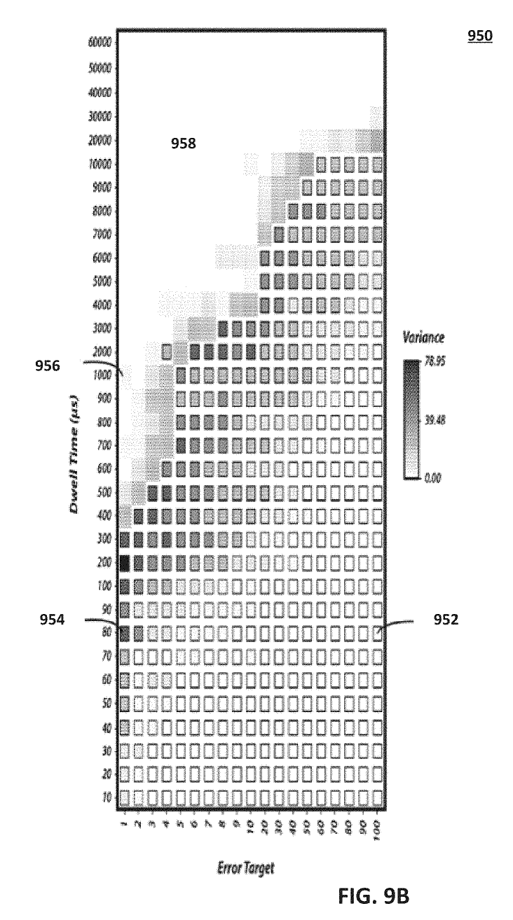

If the result of the conditional branch 812 is TRUE, the lane jitter test procedure 724 proceeds to block 820 where the Repeat variable is incremented by 1 (i.e., Repeat=Repeat+1). Once Repeat has been incremented, the lane jitter test procedure 724 continues to block 822a to assign a value to an Errors variable. As shown, the variable Errors is assigned a value according to a POINT TEST function, described briefly below in FIG. 9:

FIG. 9A is a diagram illustrating an algorithm loop for a POINT TEST function 901 implemented during the lane jitter test procedure. When the POINT TEST function is called (e.g., from block 822a of FIG. 8), point test algorithm 822 begins with block 902—“Read Point from Caller.” According to block 812, the point read from the caller is the value of StartPoint.

Next, block 904 provides “Set phase modulator to induce the correct amount of jitter” (via path 952). For example, the point received from the caller may range from 0-24. In one embodiment, if the point received from the caller is equal to 1, the phase modulator induces a minimal quantity of jitter into the tested lane. Alternatively, if the Point received from the caller is 24, the phase modulator induces a maximum quantity of jitter into the tested lane.

In some embodiments, in order to set the phase modulator to induce the correct level of jitter into a lane, a minimum period of time must elapse to sufficiently induce errors within the lane. The period of time to generate a target quantity of errors may be referred to as the “dwell time.” Once the phase modulator induces jitter into the lane, the POINT TEST function moves to block 906—“Wait for Dwell Time.”

Now referring to FIG. 9B, a diagram illustrating a table 950 listing the dwell time per error target is shown. As shown, a table 950 illustrates various points 952 of dwell times per various error targets. Points 952 with dark shade are values outside of the usable range. In addition, the darker shade of point 954 indicates an elevated statistical variance.

Area 958 of the table 950 consists of acceptable dwell times for each error target. For instance, for an error target of 1, a dwell time of 400-500 microseconds may be suitable. However, a dwell time of 1000 microseconds (e.g., point 956) provides enough time for random error events (i.e., intersymbol interferences) to occur. As such, a dwell time may be comparatively large relative to a clock frequency of the link.

The error target may be configurable as shown in table 950. For example, the error target may be configured to any number such as, but not limited to, between 1 and 100. In one embodiment, for an error target configured to 1, an acceptable dwell time exceeds 400 microseconds. It should be understood by one having ordinary skill in the art that the time period of the link health experiment procedure and particularly the time period for the POINT TEST function to transpire may be considered when choosing the dwell time for a particular error target.

Further, the duty cycle of the jitter signal generated by the phase modulator and induced into each respective lane may be as low as 5%. As such, to induce an effective level of jitter, the worst case peaking of a duty cycle should align in phase with the worst case intersymbol interference (ISI) occurring randomly. Therefore, it may be advantageous in one embodiment to choose a sufficient dwell time for ISI events to occur.

Returning back to the POINT TEST function 822 of FIG. 9A, after the sufficient dwell time has elapsed, the function proceeds to block 908—“Read number of errors that occurred.” Accordingly, after the phase modulator induces a predetermined level of jitter in a lane, the number of errors (e.g., CRC errors) of the tested lane is read therefrom. In one embodiment, the maximum level of jitter that the link can withstand at the initial point of failure may be construed as the link's jitter tolerance.

Next, the POINT TEST function proceeds to block 910 to return the number of errors to the caller (e.g., block 822a of the lane jitter test procedure 724).

Now referring back to the lane jitter test procedure 801 illustrated in FIG. 8, the number of errors returned from the POINT TEST function is assigned to the Errors variable at block 812. Next, path 873 leads to block 813 which compares Errors to Error Target. In particular, block 824 is a conditional branch—“Errors>Error Target.” If the result of the conditional branch is NOT TRUE, the procedure 724 proceeds to block 826.

Block 826 sets the Direction variable to positive one (1) if the result of the conditional branch is NOT TRUE. If the result of the conditional branch at block 824 is TRUE, the lane jitter test procedure 724 proceeds to block 828 and sets the Direction variable to negative one (−1). The Direction variable may be set to any of various positive or negative integer constants.

The present disclosure is not limited to setting the Direction variable to 1 or −1 or another integer. The Direction variable may be set to any number which enables the lane jitter test procedure 724 to determine at which point the tested lane begins to fail.

After a value has been assigned to Direction, block 830 provides that the Point variable is calculated by assigning the variable the sum of the values of StartPoint and Direction as illustrated in the figure. After the value of the Point variable is calculated, the lane jitter test procedure 724 to block 832 which provides the following conditional statement: Point<MAX Point and Point≧0.

If the result of the conditional statement at block 832 is TRUE, the lane jitter test procedure 724 proceeds to block 833 where the value of the PreviousErrors variable is assigned the value of Errors. Next, block 822b which assigns a value to the Errors variable. As shown in the figure, the value assigned to Errors is provided by the POINT TEST function 822 (shown in FIG. 9A) (at the value of the Point variable).

As described above in reference to FIG. 9A, the POINT TEST function returns the quantity of errors which occurs after the phase modulator induces a target level of jitter into the tested lane. In particular, the phase modulator may induce a level of jitter in the lane consistent with the value of the Point variable sent to the POINT TEST function.

In the event the result of the conditional statement at block 832 is NOT TRUE, the lane jitter test procedure 724 proceeds to block 834, which provides another conditional statement: Direction<0. If the value of the Direction variable is less than 0 (e.g., −1), the procedure 724 proceeds to block 836 where the value of the Score variable is assigned the value of 0. In this instance, the value of Point has decremented to its lowest possible value (e.g., 0).

If the result of the conditional statement is TRUE (i.e., the value of Direction is greater than 1), the lane jitter test procedure 724 moves to block 838 where the value of Score is assigned the maximum point (e.g., 24). In this instance, the value of Point has incremented to its highest possible value.

Once the value of Score has been assigned, the lane jitter test procedure 724 uses the scores to determine the value of the new StartPoint in block 840 (i.e., StartPoint=Score−1).

Returning back to block 822b, once the POINT TEST function returns a value which is assigned to Errors, the lane jitter test procedure 724 proceeds to block 844. As shown, block 844 provides a conditional statement (Direction<0?). If the result of the conditional statement at block 844 is TRUE, the procedure proceeds via to block 848 which provides another conditional statement (Errors<Error Target?).

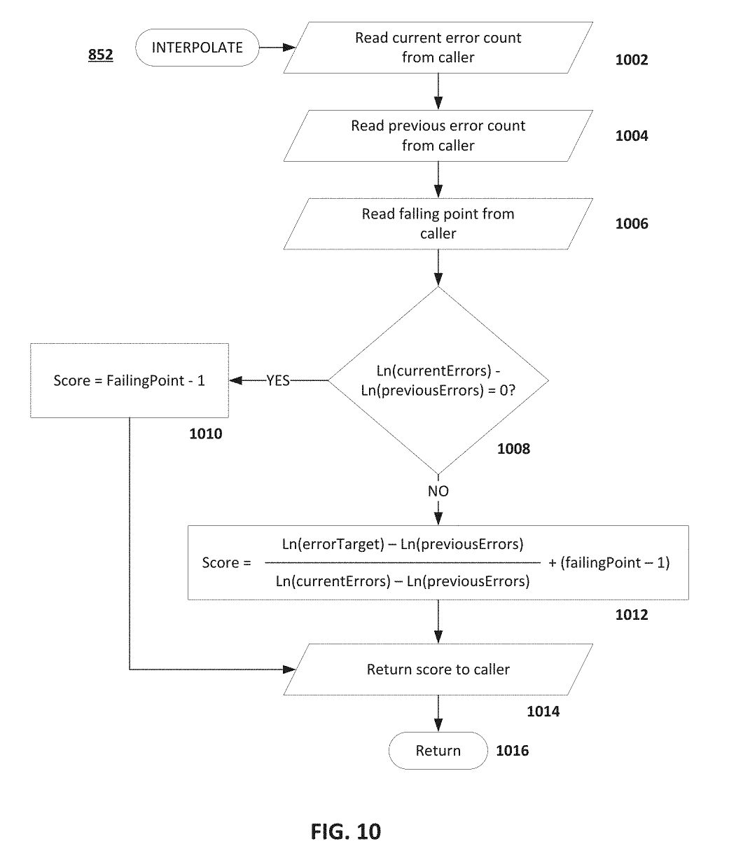

The result of the conditional statement at block 848 may lead to block 850 or block 852. If the result of the conditional statement at block 848 is TRUE, Score is assigned the value returned from an INTERPOLATE function at 852. The INTERPOLATE function is described below in detail in reference to FIG. 10.

FIG. 10 is a diagram illustrating a flowchart for a interpolate procedure 852 implemented during the lane jitter test 724. As shown, the interpolate procedure 852 starts at block 1002—“Read Current Error Count from Caller.”

Once the current error is read from the caller, the interpolate procedure 852 proceeds to block 1004—“Read Previous Error Count from Caller” and subsequently proceeds to block 1006—“Read Failing Point from Caller.” The INTERPOLATE procedure 852 reads the Current Error Count, Previous Error Count, and Failing Point from the caller (e.g., block 852 of FIG. 8). In one embodiment, the Current Error Count is read from the Errors variable, the Previous Error Count is read from the PreviousErrors variable, and the Failing Point is read from the Point variable as illustrated in FIG. 8.

Next, interpolate procedure 852 provides a conditional statement in block 1008—“ln(CurrentErrors)−ln(PreviousErrors)=0?”. If the result of the conditional statement in block 1008 is TRUE, the interpolate procedure 852 proceeds to bolock 1010, where Score is calculated according to the formula shown in block 1006 (Score=FailingPoint−1) and is returned (1014) to the caller (e.g., block 852 of FIG. 8).

If the result of the conditional statement in block 1008 is NOT TRUE, the interpolate procedure 852 moves to block 1012 to calculate the variable Score according to the following score equation below:

Score=[ln(ErrorTarget)−ln(PreviousErrors)]/[ln(CurrentErrors)−ln(PreviousErrors)]+(FailingPoint−1).

As expressed in the aforementioned equation, interpolation is performed between the failing point and the point before it. In one embodiment, logarithmic interpolation is used because of its superior noise filtering capability. Interpolation may be performed between the number of errors discovered at the failing point and the point before it. In one embodiment, a point is considered failing once the number of errors (e.g., CRC errors) causes the lane to fail.

In one embodiment, the value of Score will be between 0 and 24. However, one having ordinary skill in the art may appreciate that the value of Score may be within another range of numbers. For example, the range of values for the Score variable may be between 0 and 35. The maximum score may be changed based on the hardware implementation of the device (e.g., video card).

After the score is calculated according to block 1012, the interpolate procedure proceeds to block 1014 and returns the value of Score variable to the caller (e.g., the lane jitter test procedure referred to in FIG. 8).

Now referring back to FIG. 8, once Score variable is assigned the value returned from the INTERPOLATE function, the lane jitter test procedure 724 proceeds to block 840. As illustrated in the figure, block 840 provides that StartPoint is calculated by decrementing Score by 1 (i.e., StartPoint=Score−1). The lane jitter test procedure 724 will later begin testing the next lane (read from caller block 713 of FIG. 7) at one less than the initial start of failure of the previously tested lane.

It may be understood by one having ordinary skill in the art that adjacent lanes may operate similarly such that the initial start of failure between adjacent lanes are within a relatively short range of each other. It may be advantageous to begin testing at another point other than failing point (e.g., the initial start of failure) of the previously tested lane in order to prevent the next tested lane from immediately failing thereby disrupting the system. For instance, if the next lane is induced with jitter at a level which caused the previously tested lane to fail, the system may downgrade the transmission speed of the tested lane to a lower speed (e.g., from PCIe Gen3 speed to PCIe Gen1 or Gen2 speed).

Moreover, the present disclosure is not limited to decrementing Score by 1 at block 827 in an effort to prevent the next tested lane from failing immediately. Score may be decremented or incremented by any predetermined constant or variable in order to prevent the next lane from failing immediately during the lane jitter test procedure for the next lane.

Returning back to block 844, in the event that the result of the conditional statement (Direction<0?) is NOT TRUE, the lane jitter test procedure 724 proceeds to block 846. As illustrated, block 846 provides the following conditional statement: “Errors≧Error Target?” If the result of the conditional statement at block 824 is TRUE, procedure 801 continues along path 844 to block 826.

For example, if Direction is set to positive one (1) and Errors is greater than or equal to Error Target, the value of Point was incremented to induce a higher level of jitter into the lane which generated errors in the tested lane which met or exceeded the Error Target. In contrast, if the result of the conditional statement in block 846 is NOT TRUE, the value of Point and level of jitter consistent thereto was insufficient to cause the link to fail. As such, Point will be incremented again at block 850 in order to induce an even higher level of jitter into the lane unless Point has reached the maximum value (see block 832).

Returning to block 840, once the value of the StartPoint variable is calculated, the lane jitter test procedure 724 moves to block 852. Block 852 provides another conditional statement (i.e., StartPoint<0?). If the result of the conditional statement at block 852 is TRUE, the procedure 724 proceeds to block 854 and sets StartPoint to 0 and then moves to block 856 to CALCULATE DIFFERENCE between score and LastScore. If the result of the conditional statement at block 852 is NOT TRUE, the value of the StartPoint variable is maintained from the calculation at block 840.

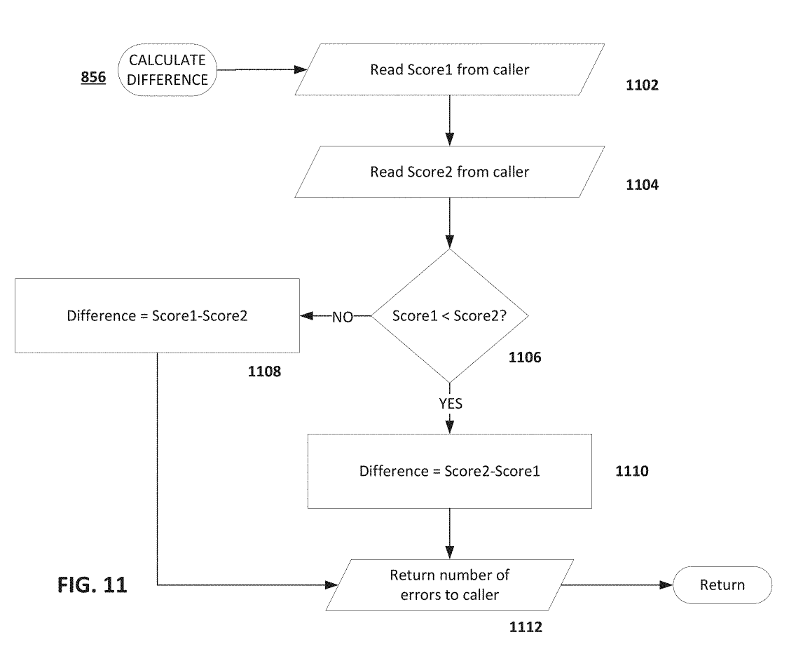

Difference is calculated at block 856. As shown, Difference is calculated according to CALCULATE DIFFERENCE function 856 using the values of Score and LastScore. The CALCULATE DIFFERENCE function is described in more detail with reference to FIG. 11.

FIG. 11 is a diagram illustrating a flowchart for a CALCULATE DIFFERENCE function 856 implemented during the lane jitter test procedure 724. As shown, the CALCULATE DIFFERENCE function 856, proceeds to block 1102—“Read Score1 from Caller.” In one embodiment, Score1 is assigned the value of Score. Next, procedure 856 reads Score2 which is assigned the value of the LastScore (1104).

After Score1 and Score2 are read from the caller, the CALCULATE DIFFERENCE function 856 moves to block 1106 which compares the magnitude of Score1 and Score2. If the result of the conditional statement is NOT TRUE, the function 856 to block 1108, where the value of Difference is calculated by taking the difference of Score1 and Score2 (Difference=Score1—Score2). If the result of the conditional statement is TRUE, the value of Difference is calculated by taking the difference of Score2 and Score1 as illustrated at block 1110 (i.e., Difference=Score2−Score1). Accordingly, blocks 1106-1110 ensure that Difference is a non-negative value. Difference is returned to the caller (e.g., block 856) as shown by block 1112.

Returning to FIG. 8, block 858 determines whether Difference≦1. The result of the conditional statement at block 858 determines the value of Convergence.

If the conditional statement at block 858 is NOT TRUE, the lane jitter test procedure 724 continues to block 860 and sets Convergence to 0. If the conditional statement is TRUE, the procedure 724 proceeds to block 862, where Convergence is incremented by 1 (Convergence=Convergence+1).

Block 864 assigns the value of LastScore to the value of Score. Further, the lane jitter test procedure 724 proceeds to the conditional statement at block 812 as described above.

In one embodiment, if similar scores are returned a consecutive number of times (e.g., 3) for a particular TxEQ of a tested lane, while having performed the jitter test less than a predetermined number of iterations (e.g., 30) for the lane, the lane jitter test procedure 724 will proceed to block 814. Finally, at block 814, the device (e.g., phase modulator) which induced artificial jitter in the tested lane is turned off. The score can be returned to caller 816, and the subroutine can return 818.

In one embodiment, a phase modulator is used to generate and induce jitter into the lane(s). The phase modulator may include an electronic circuit which causes a phase angle of a modulated wave to vary in accordance with a modulated signal. Most notably, the phase modulator may be operable to effect various jitter signals to induce varying levels of jitter into a communication link with the intent to test the performance of the lane at each jitter level induced into the lane. Additionally, the jitter signal generated by the phase modulator may align in phase with an intersymbol interference event in the lane to create a maximum level of jitter during the duty cycle of the jitter signal.

In some instances, injecting a high level of jitter into the lane may cause the analog control loops to have an over-damped oscillatory response. In this event, the jitter tolerance of the link may oscillate with the analog control loops. Advantageously, link jitter test procedure 724 allows the analog control loops to settle and stabilize to increase the integrity and reliability of a given measurement.

To account for these oscillation events, testing may be repeated several times to ensure that the measurement results converge to within one point of the previous measurement multiple times in a row. In one embodiment, the jitter test procedure may be repeated a limited number of times to prevent the procedure 724 from entering into an infinite loop.

In addition, the phase modulator may have multiple settings wherein each setting induces a particular level of artificial jitter in the tested lane. In one embodiment, a phase modulator consistent with the present disclosure has 25 settings (e.g., settings 0-24) wherein each successive setting generates a higher level of artificial jitter. For example, setting 0 may not induce any jitter in a tested lane whereas setting 24 induces the highest level of jitter in the tested lane. Furthermore, each setting of a phase modulator may be obtained by adjusting the amplitude of an oscilloscope device coupled thereto.

One having ordinary skill in the art may appreciate that the present disclosure is not limited to a phase modulator to induce artificial jitter in a lane. Any system consistent with the present disclosure may be used to induce artificial jitter in each lane of a tested link.

Referring back to block 807, if the result of the conditional statement is NOT TRUE, the phase modulator is turned off 814 and the value of Score is returned to the caller (e.g., block 724 of algorithm loop 606).

Returning to FIG. 7, the link health experiment algorithm 606 moves to perform a lane voltage (VOC) corners test (726). The VOC test 726 is described in more detail in FIG. 12A:

FIG. 12A is a process flow diagram 728 for performing a lane voltage testing in accordance with embodiments of the present disclosure. VOC test 728 starts by reading the lane from the caller (1202). The Repeat is initially set to 0 (1204). A determination is made as to the repeat value (Repeat<2) (1206). If repeat is greater than 2, then the operation fails (1207).

If the repeat is less than 2 (at 1206), then the repeat is incremented (repeat=repeat+1) (1208), and the voltage testing begins:

The voltage can be set to a high side point (1210). The process can wait for a dwell time (1212). Dwell times are discussed below in connection with FIG. 12B below.

After a dwell time, the number of errors that occurred can be determined (1214). If the number of errors is greater than the VOC error target (1216), then the process can return to (1206). If the errors less than the VOC error target (1216), then the voltage can be set to the low side point (1218). The process can wait a second dwell time (1220). After the second dwell time, the number of errors that occurred can be determined (1222). If the number of errors is less than the VOC error target (1224), then the test passes. If the number of errors is greater than the VOC error target, then the process returns to 1206.

Voltage (VOC) testing includes a dwell time that is one order of magnitude higher than what is needed to test jitter tolerance. FIG. 12B is a schematic diagram of dwell times per error target in accordance with embodiments of the present disclosure. Without the increased dwell time, accurate voltage test data might not be observed. Due to the order of magnitude increase in dwell time, determining the voltage margin would take approximately 7.68 seconds on average, with a worst case scenario of 75 seconds. These test times are large enough that doing a full voltage margin test would not be feasible. Instead of trying to determine exactly how much voltage margin is present, only check to make sure that there is sufficient margin to ensure a healthy link. Only one point on the positive voltage scale and one on the negative voltage scale are tested. These two corners make up the minimum voltage margin check.

Much like the jitter tolerance test, the voltage test also has dwell time and error target parameters that need to be calibrated. Experimental data shows that the calibration for voltage testing needs to be kept independent from the calibration done for jitter tolerance testing. The same calibration technique was used for jitter tolerance. Specifically, search across a large space of possible dwell time and error target combinations and graph the variance of the voltage margin results.

The goal is to select a point with the minimum possible variance in test results at the smallest possible dwell time. This point would imply that the algorithm will select the same TxEQ coefficients every time for a given platform. The graph for voltage margining may be different than the data from jitter tolerance. The graph is shown in FIG. 12B. A possible dwell time that can be at 10 ms and an error target at 2 (point 1252).d

Through statistical analysis of data from electrical validation, in some embodiments, the high side point may be set to 15 steps of voltage stimulus. In some embodiments, the low side point should be −15. In some embodiments, the values of high=5 and low=−6 steps are used instead.

For voltage margining, in some embodiments, a dwell time of 10 ms and an error target of 2 can be used. Compared to jitter tolerance which has a 1 ms dwell time and an error target of 1, the voltage margin uses an order of magnitude longer execution time.

Since only the VOC corners test is performed instead of a full margin test, on average this adds approximately 960 ms to the algorithm's execution time. The execution time for the original algorithm was 750 ms, this makes the average execution time for the enhanced algorithm approximately 1.7 seconds.

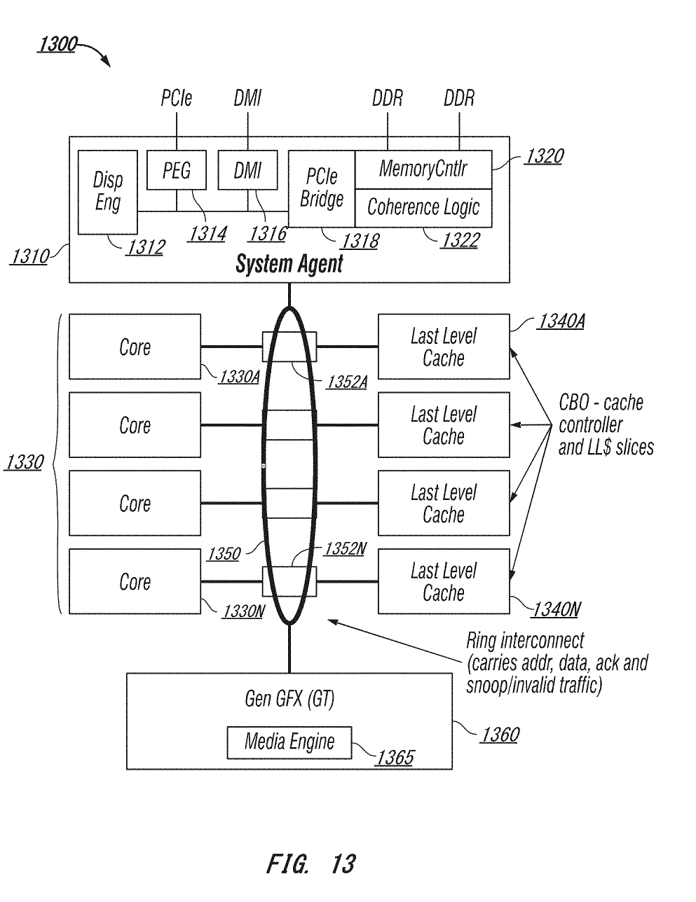

Referring now to FIG. 13, shown is a block diagram of an embodiment of a multicore processor. As shown in the embodiment of FIG. 13, processor 1300 includes multiple domains. Specifically, a core domain 1330 includes a plurality of cores 1330A-1330N, a graphics domain 1360 includes one or more graphics engines having a media engine 1365, and a system agent domain 1310.

In various embodiments, system agent domain 1310 handles power control events and power management, such that individual units of domains 1330 and 1360 (e.g. cores and/or graphics engines) are independently controllable to dynamically operate at an appropriate power mode/level (e.g. active, turbo, sleep, hibernate, deep sleep, or other Advanced Configuration Power Interface like state) in light of the activity (or inactivity) occurring in the given unit. Each of domains 1330 and 1360 may operate at different voltage and/or power, and furthermore the individual units within the domains each potentially operate at an independent frequency and voltage. Note that while only shown with three domains, understand the scope of the present invention is not limited in this regard and additional domains may be present in other embodiments.

As shown, each core 1330 further includes low level caches in addition to various execution units and additional processing elements. Here, the various cores are coupled to each other and to a shared cache memory that is formed of a plurality of units or slices of a last level cache (LLC) 1340A-1340N; these LLCs often include storage and cache controller functionality and are shared amongst the cores, as well as potentially among the graphics engine too.

As seen, a ring interconnect 1350 couples the cores together, and provides interconnection between the core domain 1330, graphics domain 1360 and system agent circuitry 1310, via a plurality of ring stops 1352A-1352N, each at a coupling between a core and LLC slice. As seen in FIG. 13, interconnect 1350 is used to carry various information, including address information, data information, acknowledgement information, and snoop/invalid information. Although a ring interconnect is illustrated, any known on-die interconnect or fabric may be utilized. As an illustrative example, some of the fabrics discussed above (e.g. another on-die interconnect, Intel On-chip System Fabric (IOSF), an Advanced Microcontroller Bus Architecture (AMBA) interconnect, a multi-dimensional mesh fabric, or other known interconnect architecture) may be utilized in a similar fashion.

As further depicted, system agent domain 1310 includes display engine 1312 which is to provide control of and an interface to an associated display. System agent domain 1310 may include other units, such as: an integrated memory controller 1320 that provides for an interface to a system memory (e.g., a DRAM implemented with multiple DIMMs; coherence logic 1322 to perform memory coherence operations. Multiple interfaces may be present to enable interconnection between the processor and other circuitry. For example, in one embodiment at least one direct media interface (DMI) 1316 interface is provided as well as one or more PCIe™ interfaces 1314. The display engine and these interfaces typically couple to memory via a PCIe™ bridge 1318. Still further, to provide for communications between other agents, such as additional processors or other circuitry, one or more other interfaces (e.g. an Intel® Quick Path Interconnect (QPI) fabric) may be provided.

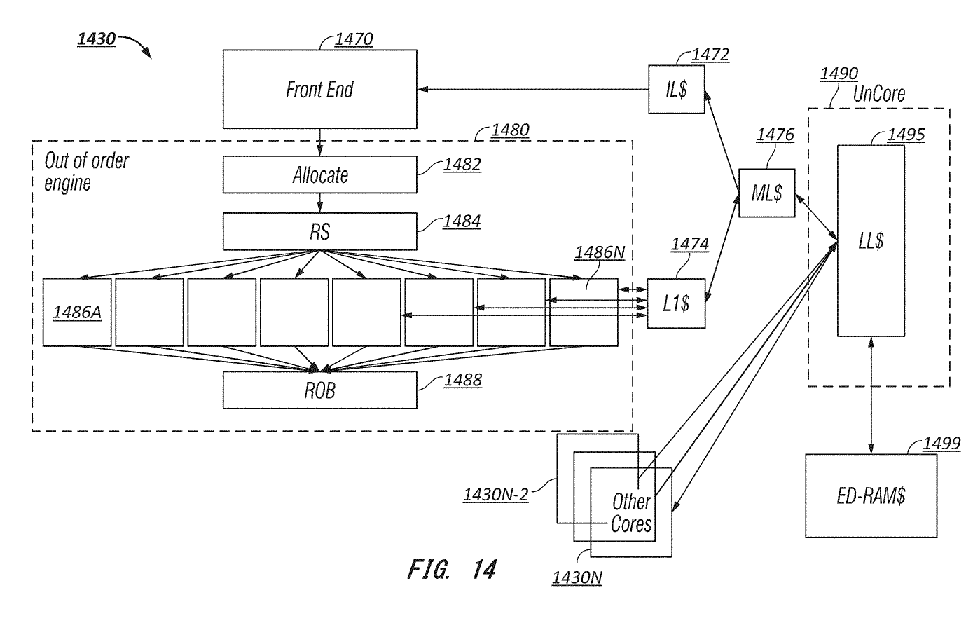

Referring now to FIG. 14, shown is a block diagram of a representative core; specifically, logical blocks of a back-end of a core, such as core 1330 from FIG. 13. In general, the structure shown in FIG. 14 includes an out-of-order processor that has a front end unit 1470 used to fetch incoming instructions, perform various processing (e.g. caching, decoding, branch predicting, etc.) and passing instructions/operations along to an out-of-order (000) engine 1480. OOO engine 1480 performs further processing on decoded instructions.

Specifically in the embodiment of FIG. 14, out-of-order engine 1480 includes an allocate unit 1482 to receive decoded instructions, which may be in the form of one or more micro-instructions or uops, from front end unit 1470, and allocate them to appropriate resources such as registers and so forth. Next, the instructions are provided to a reservation station 1484, which reserves resources and schedules them for execution on one of a plurality of execution units 1486A-1486N. Various types of execution units may be present, including, for example, arithmetic logic units (ALUs), load and store units, vector processing units (VPUs), floating point execution units, among others. Results from these different execution units are provided to a reorder buffer (ROB) 1488, which take unordered results and return them to correct program order.

Still referring to FIG. 14, note that both front end unit 1470 and out-of-order engine 1480 are coupled to different levels of a memory hierarchy. Specifically shown is an instruction level cache 1472, that in turn couples to a mid-level cache 1476, that in turn couples to a last level cache 1495. In one embodiment, last level cache 1495 is implemented in an on-chip (sometimes referred to as uncore) unit 1490. As an example, unit 1490 is similar to system agent 1310 of FIG. 13. As discussed above, UnCore 1490 communicates with system memory 1499, which, in the illustrated embodiment, is implemented via ED RAM. Note also that the various execution units 1486 within out-of-order engine 1480 are in communication with a first level cache 1474 that also is in communication with mid-level cache 1476. Note also that additional cores 1430N-2-1430N can couple to LLC 1495. Although shown at this high level in the embodiment of FIG. 14, understand that various alterations and additional components may be present.

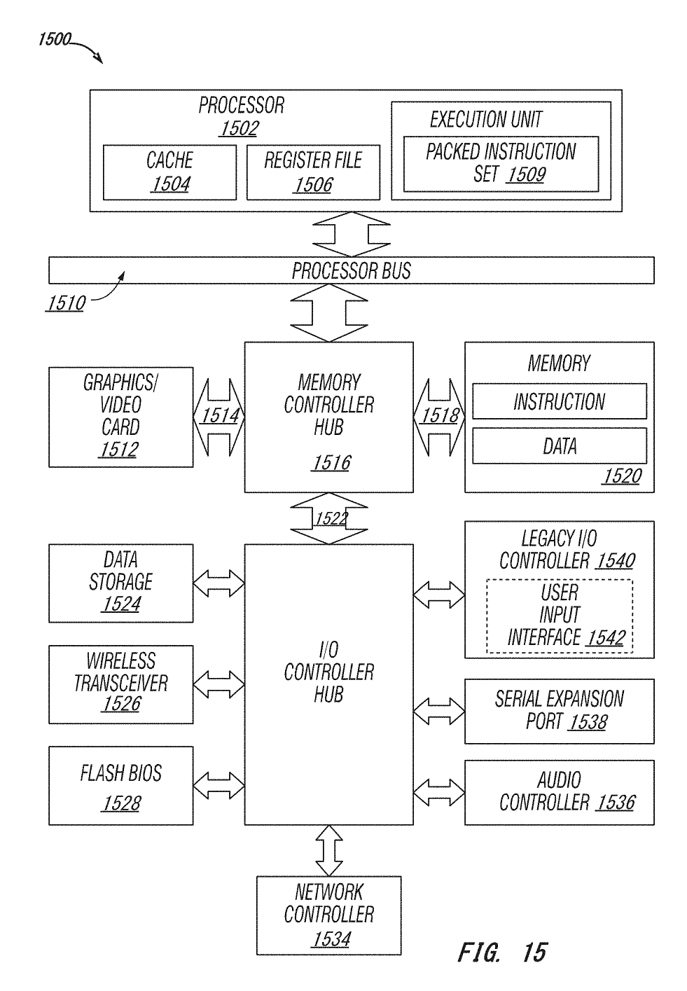

Turning to FIG. 15, a block diagram of an exemplary computer system formed with a processor that includes execution units to execute an instruction, where one or more of the interconnects implement one or more features in accordance with one embodiment of the present invention is illustrated. System 1500 includes a component, such as a processor 1502 to employ execution units including logic to perform algorithms for process data, in accordance with the present invention, such as in the embodiment described herein. System 1500 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 1500 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 1502 includes one or more execution units 1508 to implement an algorithm that is to perform at least one instruction. One embodiment may be described in the context of a single processor desktop or server system, but alternative embodiments may be included in a multiprocessor system. System 1500 is an example of a ‘hub’ system architecture. The computer system 1500 includes a processor 1502 to process data signals. The processor 1502, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 1502 is coupled to a processor bus 1510 that transmits data signals between the processor 1502 and other components in the system 1500. The elements of system 1500 (e.g. graphics accelerator 1512, memory controller hub 1516, memory 1520, I/O controller hub 1524, wireless transceiver 1526, Flash BIOS 1528, Network controller 1534, Audio controller 1536, Serial expansion port 1538, I/O controller 1540, etc.) perform their conventional functions that are well known to those familiar with the art.

In one embodiment, the processor 1502 includes a Level 1 (L1) internal cache memory 1504. Depending on the architecture, the processor 1502 may have a single internal cache or multiple levels of internal caches. Other embodiments include a combination of both internal and external caches depending on the particular implementation and needs. Register file 1506 is to store different types of data in various registers including integer registers, floating point registers, vector registers, banked registers, shadow registers, checkpoint registers, status registers, and instruction pointer register.

Execution unit 1508, including logic to perform integer and floating point operations, also resides in the processor 1502. The processor 1502, in one embodiment, includes a microcode (ucode) ROM to store microcode, which when executed, is to perform algorithms for certain macroinstructions or handle complex scenarios. Here, microcode is potentially updateable to handle logic bugs/fixes for processor 1502. For one embodiment, execution unit 1508 includes logic to handle a packed instruction set 1509. By including the packed instruction set 1509 in the instruction set of a general-purpose processor 1502, along with associated circuitry to execute the instructions, the operations used by many multimedia applications may be performed using packed data in a general-purpose processor 1502. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 1508 may also be used in micro controllers, embedded processors, graphics devices, DSPs, and other types of logic circuits. System 1500 includes a memory 1520. Memory 1520 includes a dynamic random access memory (DRAM) device, a static random access memory (SRAM) device, flash memory device, or other memory device. Memory 1520 stores instructions and/or data represented by data signals that are to be executed by the processor 1502.

Note that any of the aforementioned features or aspects of the invention may be utilized on one or more interconnect illustrated in FIG. 15. For example, an on-die interconnect (ODI), which is not shown, for coupling internal units of processor 1502 implements one or more aspects of the invention described above. Or the invention is associated with a processor bus 1510 (e.g. Intel Quick Path Interconnect (QPI) or other known high performance computing interconnect), a high bandwidth memory path 1518 to memory 1520, a point-to-point link to graphics accelerator 1512 (e.g. a Peripheral Component Interconnect express (PCIe) compliant fabric), a controller hub interconnect 1522, an I/O or other interconnect (e.g. USB, PCI, PCIe) for coupling the other illustrated components. Some examples of such components include the audio controller 1536, firmware hub (flash BIOS) 1528, wireless transceiver 1526, data storage 1524, legacy I/O controller 1510 containing user input and keyboard interfaces 1542, a serial expansion port 1538 such as Universal Serial Bus (USB), and a network controller 1534. The data storage device 1524 can comprise a hard disk drive, a floppy disk drive, a CD-ROM device, a flash memory device, or other mass storage device.

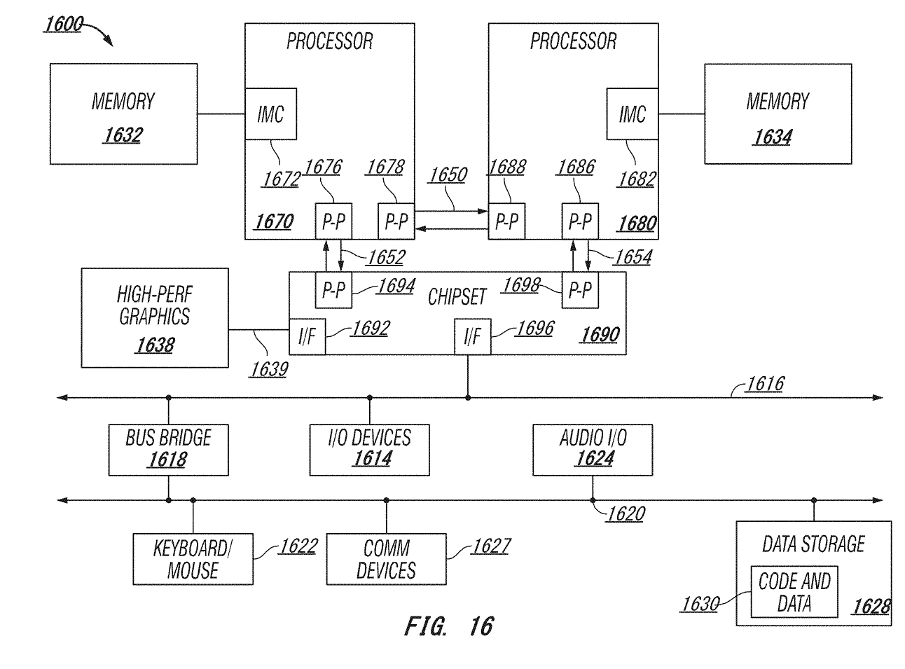

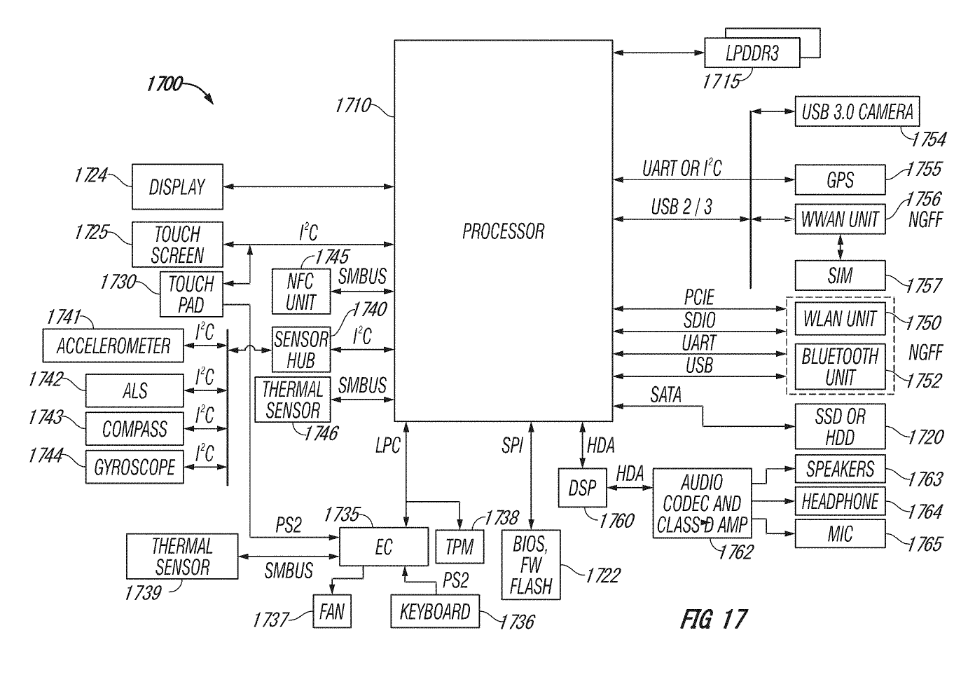

Referring now to FIG. 16, shown is a block diagram of a second system 1600 in accordance with an embodiment of the present invention. As shown in FIG. 16, multiprocessor system 1600 is a point-to-point interconnect system, and includes a first processor 1670 and a second processor 1680 coupled via a point-to-point interconnect 1650. Each of processors 1670 and 1680 may be some version of a processor. In one embodiment, 1652 and 1654 are part of a serial, point-to-point coherent interconnect fabric, such as Intel's Quick Path Interconnect (QPI) architecture. As a result, the invention may be implemented within the QPI architecture.

While shown with only two processors 1670, 1680, it is to be understood that the scope of the present invention is not so limited. In other embodiments, one or more additional processors may be present in a given processor.

Processors 1670 and 1680 are shown including integrated memory controller units 1672 and 1682, respectively. Processor 1670 also includes as part of its bus controller units point-to-point (P-P) interfaces 1676 and 1678; similarly, second processor 1680 includes P-P interfaces 1686 and 1688. Processors 1670, 1680 may exchange information via a point-to-point (P-P) interface 1650 using P-P interface circuits 1678, 1688. As shown in FIG. 16, IMCs 1672 and 1682 couple the processors to respective memories, namely a memory 1632 and a memory 1634, which may be portions of main memory locally attached to the respective processors.

Processors 1670, 1680 each exchange information with a chipset 1690 via individual P-P interfaces 1652, 1654 using point to point interface circuits 1676, 1694, 1686, 1698. Chipset 1690 also exchanges information with a high-performance graphics circuit 1638 via an interface circuit 1692 along a high-performance graphics interconnect 1639.

A shared cache (not shown) may be included in either processor or outside of both processors; yet connected with the processors via P-P interconnect, such that either or both processors' local cache information may be stored in the shared cache if a processor is placed into a low power mode.

Chipset 1690 may be coupled to a first bus 1616 via an interface 1696. In one embodiment, first bus 1616 may be a Peripheral Component Interconnect (PCI) bus, or a bus such as a PCI Express bus or another third generation I/O interconnect bus, although the scope of the present invention is not so limited.

As shown in FIG. 16, various I/O devices 1614 are coupled to first bus 1616, along with a bus bridge 1618 which couples first bus 1616 to a second bus 1620. In one embodiment, second bus 1620 includes a low pin count (LPC) bus. Various devices are coupled to second bus 1620 including, for example, a keyboard and/or mouse 1622, communication devices 1627 and a storage unit 1628 such as a disk drive or other mass storage device which often includes instructions/code and data 1630, in one embodiment. Further, an audio I/O 1624 is shown coupled to second bus 1620. Note that other architectures are possible, where the included components and interconnect architectures vary. For example, instead of the point-to-point architecture of FIG. 16, a system may implement a multi-drop bus or other such architecture.

Referring now to FIG. 17, a block diagram of components present in a computer system in accordance with an embodiment of the present invention is illustrated. As shown in FIG. 17, system 1700 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 17 is intended to show a high level view of many components of the computer system. However, it is to be understood that some of the components shown may be omitted, additional components may be present, and different arrangement of the components shown may occur in other implementations. As a result, the invention described above may be implemented in any portion of one or more of the interconnects illustrated or described below.

As seen in FIG. 17, a processor 1710, in one embodiment, includes a microprocessor, multi-core processor, multithreaded processor, an ultra low voltage processor, an embedded processor, or other known processing element. In the illustrated implementation, processor 1710 acts as a main processing unit and central hub for communication with many of the various components of the system 1700. As one example, processor 1700 is implemented as a system on a chip (SoC). As a specific illustrative example, processor 1710 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitectural implementation may vary, but the architectural function of the processor is usually consistent. Certain details regarding the architecture and operation of processor 1710 in one implementation will be discussed further below to provide an illustrative example.

Processor 1710, in one embodiment, communicates with a system memory 1715. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (15P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 1720 may also couple to processor 1710. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 17, a flash device 1722 may be coupled to processor 1710, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (IO) devices may be present within system 1700. Specifically shown in the embodiment of FIG. 17 is a display 1724 which may be a high definition LCD or LED panel configured within a lid portion of the chassis. This display panel may also provide for a touch screen 1725, e.g., adapted externally over the display panel such that via a user's interaction with this touch screen, user inputs can be provided to the system to enable desired operations, e.g., with regard to the display of information, accessing of information and so forth. In one embodiment, display 1724 may be coupled to processor 1710 via a display interconnect that can be implemented as a high performance graphics interconnect. Touch screen 1725 may be coupled to processor 1710 via another interconnect, which in an embodiment can be an I²C interconnect. As further shown in FIG. 17, in addition to touch screen 1725, user input by way of touch can also occur via a touch pad 1730 which may be configured within the chassis and may also be coupled to the same I²C interconnect as touch screen 1725.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080p), be compatible with an embedded display port (eDP), and be a low power panel with panel self refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited IO interference when using multi-touch.

For perceptual computing and other purposes, various sensors may be present within the system and may be coupled to processor 1710 in different manners. Certain inertial and environmental sensors may couple to processor 1710 through a sensor hub 1740, e.g., via an I²C interconnect. In the embodiment shown in FIG. 17, these sensors may include an accelerometer 1741, an ambient light sensor (ALS) 1742, a compass 1743 and a gyroscope 1744. Other environmental sensors may include one or more thermal sensors 1746 which in some embodiments couple to processor 1710 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

In an embodiment, the OS may be a Microsoft® Windows® 8 OS that implements Connected Standby (also referred to herein as Win8 CS). Windows 8 Connected Standby or another OS having a similar state can provide, via a platform as described herein, very low ultra idle power to enable applications to remain connected, e.g., to a cloud-based location, at very low power consumption. The platform can supports 3 power states, namely screen on (normal); Connected Standby (as a default “off” state); and shutdown (zero watts of power consumption). Thus in the Connected Standby state, the platform is logically on (at minimal power levels) even though the screen is off. In such a platform, power management can be made to be transparent to applications and maintain constant connectivity, in part due to offload technology to enable the lowest powered component to perform an operation.

Also seen in FIG. 17, various peripheral devices may couple to processor 1710 via a low pin count (LPC) interconnect. In the embodiment shown, various components can be coupled through an embedded controller 1735. Such components can include a keyboard 1736 (e.g., coupled via a PS2 interface), a fan 1737, and a thermal sensor 1739. In some embodiments, touch pad 1730 may also couple to EC 1735 via a PS2 interface. In addition, a security processor such as a trusted platform module (TPM) 1738 in accordance with the Trusted Computing Group (TCG) TPM Specification Version 1.2, dated Oct. 2, 2003, may also couple to processor 1710 via this LPC interconnect. However, understand the scope of the present invention is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus Revision 3.0 Specification (November 2008), with at least one powered for charging of USB devices (such as smartphones) when the system is in Connected Standby state and is plugged into AC wall power. In addition, one or more Thunderbolt′ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 1700 can communicate with external devices in a variety of manners, including wirelessly. In the embodiment shown in FIG. 17, various wireless modules, each of which can correspond to a radio configured for a particular wireless communication protocol, are present. One manner for wireless communication in a short range such as a near field may be via a near field communication (NFC) unit 1745 which may communicate, in one embodiment with processor 1710 via an SMBus. Note that via this NFC unit 1745, devices in close proximity to each other can communicate. For example, a user can enable system 1700 to communicate with another (e.g.,) portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 17, additional wireless units can include other short range wireless engines including a WLAN unit 1750 and a Bluetooth unit 1752. Using WLAN unit 1750, Wi-Fi™ communications in accordance with a given Institute of Electrical and Electronics Engineers (IEEE) 802.11 standard can be realized, while via Bluetooth unit 1752, short range communications via a Bluetooth protocol can occur. These units may communicate with processor 1710 via, e.g., a USB link or a universal asynchronous receiver transmitter (UART) link. Or these units may couple to processor 1710 via an interconnect according to a Peripheral Component Interconnect Express™ (PCIe™) protocol, e.g., in accordance with the PCI Express' Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 1756 which in turn may couple to a subscriber identity module (SIM) 1757. In addition, to enable receipt and use of location information, a GPS module 1755 may also be present. Note that in the embodiment shown in FIG. 17, WWAN unit 1756 and an integrated capture device such as a camera module 1754 may communicate via a given USB protocol such as a USB 2.0 or 3.0 link, or a UART or I²C protocol. Again the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 1760, which may couple to processor 1710 via a high definition audio (HDA) link. Similarly, DSP 1760 may communicate with an integrated coder/decoder (CODEC) and amplifier 1762 that in turn may couple to output speakers 1763 which may be implemented within the chassis. Similarly, amplifier and CODEC 1762 can be coupled to receive audio inputs from a microphone 1765 which in an embodiment can be implemented via dual array microphones (such as a digital microphone array) to provide for high quality audio inputs to enable voice-activated control of various operations within the system. Note also that audio outputs can be provided from amplifier/CODEC 1762 to a headphone jack 1764. Although shown with these particular components in the embodiment of FIG. 17, understand the scope of the present invention is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 1710 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the I/O pins for several I/O signals, such as the interface between the processor and a PCH, the interface with the external VR and the interface with EC 1735. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC 1735 may be sent to the PCH instead of the processor during the connected standby state so that the PCH can manage the wakeup processing instead of the processor. In addition, the TSC is maintained in the PCH to facilitate sustaining processor architectural functions. Although shown with these particular components in the embodiment of FIG. 17, understand the scope of the present invention is not limited in this regard.

Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

Some implementations may provide a specific power management IC (PMIC) to control platform power. Using this solution, a system may see very low (e.g., less than 5%) battery degradation over an extended duration (e.g., 16 hours) when in a given standby state, such as when in a Win8 Connected Standby state. In a Win8 idle state a battery life exceeding, e.g., 9 hours may be realized (e.g., at 150 nits). As to video playback, a long battery life can be realized, e.g., full HD video playback can occur for a minimum of 6 hours. A platform in one implementation may have an energy capacity of, e.g., 35 watt hours (Whr) for a Win8 CS using an SSD and (e.g.,) 40-44 Whr for Win8 CS using an HDD with a RST cache configuration.

A particular implementation may provide support for 15 W nominal CPU thermal design power (TDP), with a configurable CPU TDP of up to approximately 25 W TDP design point. The platform may include minimal vents owing to the thermal features described above. In addition, the platform is pillow-friendly (in that no hot air is blowing at the user). Different maximum temperature points can be realized depending on the chassis material. In one implementation of a plastic chassis (at least having to lid or base portion of plastic), the maximum operating temperature can be 52 degrees Celsius (C). And for an implementation of a metal chassis, the maximum operating temperature can be 46° C.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

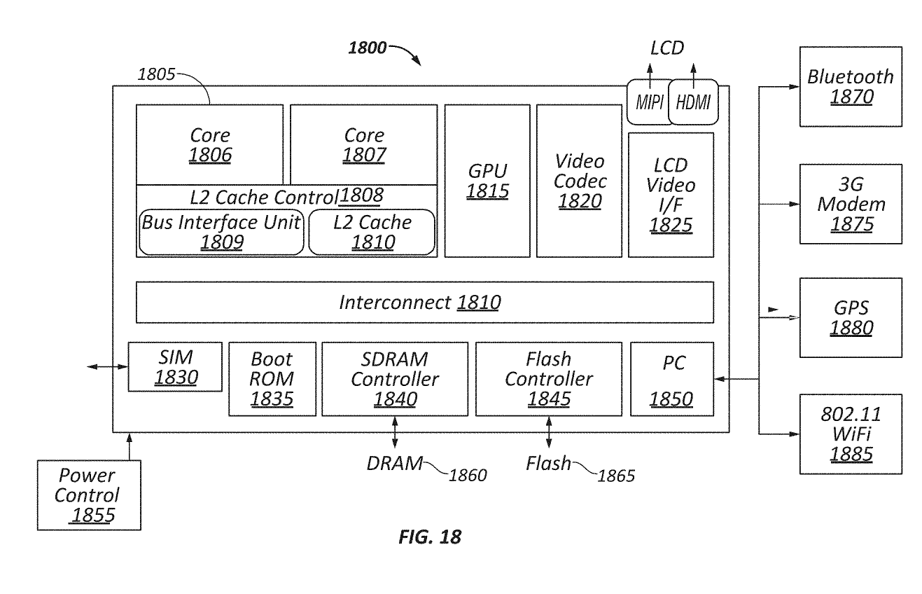

Turning next to FIG. 18, an embodiment of a system on-chip (SOC) design in accordance with the inventions is depicted. As a specific illustrative example, SOC 1800 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1800 includes 2 cores—1806 and 1807. Similar to the discussion above, cores 1806 and 1807 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1806 and 1807 are coupled to cache control 1808 that is associated with bus interface unit 1809 and L2 cache 1810 to communicate with other parts of system 1800. Interconnect 1810 includes an on-chip interconnect, such as an IOSF, AMBA, or other interconnect discussed above, which potentially implements one or more aspects of the described invention.

Interface 1810 provides communication channels to the other components, such as a Subscriber Identity Module (SIM) 1830 to interface with a SIM card, a boot rom 1835 to hold boot code for execution by cores 1806 and 1807 to initialize and boot SOC 1800, a SDRAM controller 1840 to interface with external memory (e.g. DRAM 1860), a flash controller 1845 to interface with non-volatile memory (e.g. Flash 1865), a peripheral control 1850 (e.g. Serial Peripheral Interface) to interface with peripherals, video codecs 1820 and Video interface 1825 to display and receive input (e.g. touch enabled input), GPU 1815 to perform graphics related computations, etc. Any of these interfaces may incorporate aspects of the invention described herein.

In addition, the system illustrates peripherals for communication, such as a Bluetooth module 1870, 3G modem 1875, GPS 1885, and WiFi 1885. Note as stated above, a UE includes a radio for communication. As a result, these peripheral communication modules are not all required. However, in a UE some form a radio for external communication is to be included.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

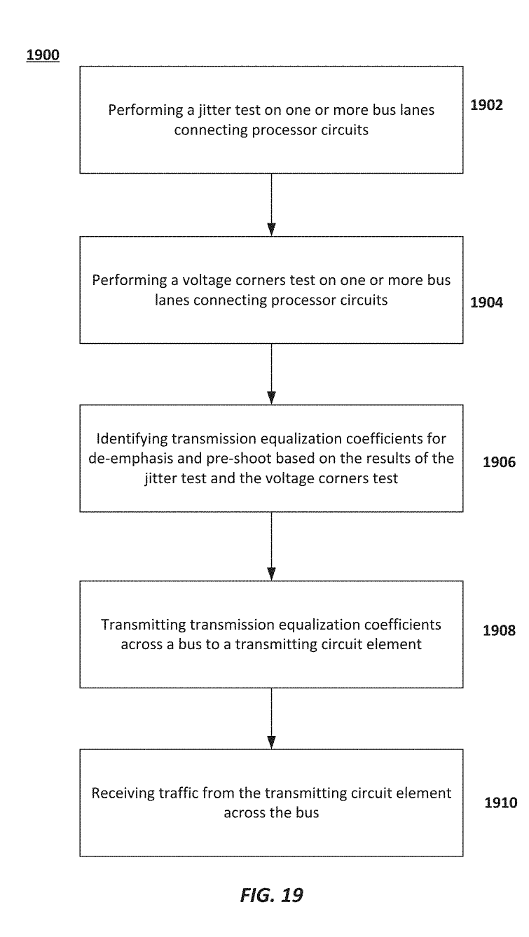

FIG. 19 is a process flow diagram 1900 for transmitting traffic across a bus using transmission equalization coefficients in accordance with embodiments of the present disclosure. Prior to receiving communications traffic from a transmitter across a bus (such as a PCIe compliant bus), a receiving circuit element can perform a jitter test on the one or more lanes of the communications bus (1902). Performing the jitter test can be performed in a manner similar to that described with FIG. 8. The receiving circuit element can perform a voltage (VOC) corners test on the one or more lanes of the communications bus (1904). The transmission equalization coefficients can be determined based on the jitter test and the voltage corners tests (1906). The receiving circuit element can provide the TxEQ coefficients to the transmitting circuit element across the bus (1908). The transmitting circuit element can apply the TxEQ coefficients to traffic sent over the lanes of the communications bus, and the receiving circuit element can receive the traffic (1910).

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

The systems, methods, and apparatuses can include one or a combination of the following examples:

Example 1 may include a receiving circuit element that includes hardware circuitry. The receiving circuit element can include logic circuitry to apply a transmission equalization coefficient to a lane of a communications link; jitter logic circuitry to perform a jitter tolerance test on the lane of a communications link using the transmission equalization coefficient; voltage logic circuitry to perform a voltage test on the lane of the communications link transmission equalization coefficient; logic circuitry to determine a best equalization coefficient for the lane based on the jitter tolerance test and based on the voltage test; and logic circuitry to provide the best equalization coefficient for the lane to a transmitting circuit element.

Example 2 may include the subject matter of example 1, and also include voltage logic circuitry to perform a voltage test comprises logic circuitry to set a high voltage point for signals transmitted on the lane; await a first predetermined amount of time; determine a number of errors at the high voltage point; determine that the number of errors at the high voltage point is less than a predetermined threshold error number; set a low voltage point for the signals transmitted on the lane; await a second predetermined amount of time; determine a number of errors at the low voltage point; determine that the number of errors at the low voltage point is less than the first predetermined threshold error number; and determine that the lane passes the voltage test based on the number of errors at the low voltage point and the number of errors at the high voltage point are less than the predetermined error number.

Example 3 may include the subject matter of any of examples 1-2, and also include logic circuitry to determine a best equalization coefficient comprises logic circuitry to determine an equalization coefficient that has an error rate below a threshold value for a highest jitter tolerance value and a lowest voltage point.

Example 4 may include the subject matter of any of examples 1-3, wherein the jitter logic circuitry is to effect various jitter signals to induce varying levels of jitter on to the lane.

Example 5 may include the subject matter of any of examples 1-4, wherein the jitter signal aligns in phase with an intersymbol interference event in the at least one lane.

Example 6 may include the subject matter of any of examples 1-5, wherein the jitter induced by the device has a duty cycle of approximately 5 percent.

Example 7 may include the subject matter of any of examples 1-6, wherein the jitter logic circuitry is a component of a phase modulator.

Example 8 may include the subject matter of any of examples 1-7, wherein the jitter logic circuitry is to induce jitter into the lane to cause the lane to fail.

Example 9 is a method at a receiving circuit element that includes applying a transmission equalization coefficient to a lane of a communications link; performing a jitter tolerance test on the lane of a communications link using the transmission equalization coefficient; performing a voltage test on the lane of the communications link transmission equalization coefficient; determining a best equalization coefficient for the lane based on the jitter tolerance test and based on the voltage test; and providing the best equalization coefficient for the lane to a transmitting circuit element.

Example 10 may include the subject matter of example 9, and also include setting a high voltage point for signals transmitted on the lane; awaiting a first predetermined amount of time; determining a number of errors at the high voltage point; determining that the number of errors at the high voltage point is less than a predetermined threshold error number; setting a low voltage point for the signals transmitted on the lane; awaiting a second predetermined amount of time; determining a number of errors at the low voltage point; determining that the number of errors at the low voltage point is less than the first predetermined threshold error number; and determining that the lane passes the voltage test based on the number of errors at the low voltage point and the number of errors at the high voltage point are less than the predetermined error number.

Example 11 may include the subject matter of any of examples 9-10, further comprising determining an equalization coefficient that has an error rate below a threshold value for a highest jitter tolerance value and a lowest voltage point.

Example 12 may include the subject matter of any of examples 9-11, wherein the maximum jitter tolerance of the best lane is determined by measuring the highest level of jitter the particular lane sustained prior to failing.

Example 13 may include the subject matter of example 12, and also include assigning a score for each measurement of the highest level of jitter for the particular lane per equalization coefficient.

Example 14 may include the subject matter of example 12, and also include assigning a score for each measurement of the highest level of jitter tolerance for each lane of the communication link per equalization coefficient.

Example 15 may include the subject matter of example 12, wherein failing includes an inability to maintain a bit error rate threshold across the particular lane according to a communication protocol.

Example 16 may include the subject matter of any of examples 9-15, and also include determining a maximum jitter tolerance for each lane of the communication link.

Example 17 may include the subject matter of any of examples 9-16, wherein the plurality of equalization coefficients includes three equalization coefficients.

Example 18 may include the subject matter of any of examples 9-17, wherein the communication link is a Peripheral Component Interconnect Express (PCIe) bus interface link.

Example 19 may include the subject matter of any of examples 9-18, wherein using the particular equalization coefficient includes retraining the communication link to the particular equalization coefficient for the particular lane of the communication link.

Example 20 may include the subject matter of any of examples 9-19, wherein the communication link has at least 16 lanes.

Example 21 is a system that includes a first component coupled to a second component wherein the first component and the second component are to communicate along a communication link; and wherein the first and second components are to determine a particular equalization coefficient of a plurality of equalization coefficients that is to yield a maximum jitter tolerance for a particular lane in response to jitter induced on the particular lane and a minimum voltage margin in response to a voltage corners test induced on the particular lane.

Example 22 may include the subject matter of example 21, wherein the first component is a root complex device and the second component is an endpoint device.

Example 23 may include the subject matter of any of examples 21-22, wherein the second component includes a video card.

Example 24 may include the subject matter of any of examples 21-23, wherein the equalization coefficient is applied to the particular lane during an operational phase in response to determining the particular equalization coefficient that is to yield the maximum jitter tolerance for the particular lane and the minimum voltage margin for the particular lane.

Example 25 may include the subject matter of any of examples 21-24, wherein the plurality of equalization coefficients includes three transmitter equalization coefficients.

Example 26 may include the subject matter of any of examples 21-25, wherein each lane is trained according to a communication protocol to the particular equalization coefficient which the second component yielded the maximum jitter tolerance.

Example 27 may include the subject matter of any of examples 21-26, wherein the first communication link includes a PCIe link.

Example 28 is an apparatus comprising means for applying a transmission equalization coefficient to a lane of a communications link; means for performing a jitter tolerance test on the lane of a communications link using the transmission equalization coefficient; means for performing a voltage test on the lane of the communications link transmission equalization coefficient; means for determining a best equalization coefficient for the lane based on the jitter tolerance test and based on the voltage test; and means for providing the best equalization coefficient for the lane to a transmitting circuit element.

Example 29 may include the subject matter of example 28, and also include means for setting a high voltage point for signals transmitted on the lane; means for awaiting a first predetermined amount of time; means for determining a number of errors at the high voltage point; means for determining that the number of errors at the high voltage point is less than a predetermined threshold error number; means for setting a low voltage point for the signals transmitted on the lane; means for awaiting a second predetermined amount of time; means for determining a number of errors at the low voltage point; means for determining that the number of errors at the low voltage point is less than the first predetermined threshold error number; and means for determining that the lane passes the voltage test based on the number of errors at the low voltage point and the number of errors at the high voltage point are less than the predetermined error number.

Example 30 may include the subject matter of any of examples 28-29, and also include means for determining an equalization coefficient that has an error rate below a threshold value for a highest jitter tolerance value and a lowest voltage point

Example 31 is a computer readable medium including code, when executed, to cause a machine to determine a jitter tolerance for each equalization coefficient of a plurality of equalization coefficients for a lane of a high speed serial link, wherein the jitter tolerance for each equalization coefficient for the lane is based on a level of jitter induced on the lane to detect a number of errors on the lane; determine a voltage margin for each equalization coefficient of the plurality of equalization coefficients for the lane of the high speed serial link, wherein the voltage margin for each equalization coefficient for the lane is based on a voltage corners test applied to the lane to detect a number of errors on the lane at a high voltage point and at a low voltage point; determine a particular equalization coefficient of the plurality of equalization coefficients that provides a maximum jitter tolerance based on the determined the jitter tolerance for each equalization coefficient and based on the determined voltage margin; and use the particular equalization coefficient for the lane during operation based on the determining the particular equalization coefficient which provides the maximum jitter tolerance and lowest voltage margin.

Example 32 may include the subject matter of example 31, wherein a wait time is observed between inducing jitter and detecting the number of errors which occurs as a result of the jitter induced on the lane.

Example 33 may include the subject matter of any of examples 31-32, wherein the wait time is between 0.1 ms and 5 ms.

Example 34 may include the subject matter of any of examples 31-33, wherein the determining the maximum jitter tolerance is repeated a number of iterations until a convergence point is achieved.

Example 35 may include the subject matter of any of examples 31-34, wherein the maximum jitter tolerance of the particular lane is determined by measuring the highest level of jitter the particular lane sustained prior to failing.

Example 36 may include the subject matter of any of examples 31-35, wherein an initial level of jitter to induce on the lane is based on a maximum jitter level of a previously trained lane of the link.

Example 37 may include the subject matter of any of examples 31-36, further including code to assign a score for each measurement of the maximum jitter tolerance for each lane of the communication link per equalization coefficient.

Example 38 may include the subject matter of any of examples 31-37, further including code to set a high voltage point for signals transmitted on the lane; await a first predetermined amount of time; determine a number of errors at the high voltage point; determine that the number of errors at the high voltage point is less than a predetermined threshold error number; set a low voltage point for the signals transmitted on the lane; await a second predetermined amount of time; determine a number of errors at the low voltage point; determine that the number of errors at the low voltage point is less than the first predetermined threshold error number; and determine that the lane passes the voltage test based on the number of errors at the low voltage point and the number of errors at the high voltage point are less than the predetermined error number.

Example 39 may include the subject matter of any of examples 31-38, further including code to determine an equalization coefficient that has an error rate below a threshold value for a highest jitter tolerance value and a lowest voltage point.

Example 40 may include the subject matter of any of examples 1-8, wherein the voltage logic circuitry is to set a high side voltage of 15 volts on the lane and a low side voltage of −15 volts on the lane.

Example 41 may include the subject matter of any of examples 1-8 and 40, wherein the voltage logic circuitry is to test a high and low voltage on the lane to cause the lane to fail.

Example 42 may include the subject matter of any of examples 9-20, wherein the voltage margin of the particular lane is determined by measuring the highest voltage level for the particular lane sustained prior to failing and measuring the lowest voltage level for the particular lane sustained prior to failing.

1. A receiving circuit element comprising:
logic circuitry to apply a transmission equalization coefficient to a lane of a communications link;
jitter logic circuitry to perform a jitter tolerance test on the lane of a communications link using the transmission equalization coefficient;
voltage logic circuitry to perform a voltage test on the lane of the communications link using the transmission equalization coefficient, wherein the voltage logic circuitry comprises logic circuitry to:
set a high voltage point for signals transmitted on the lane;
await a first predetermined amount of time;
determine a number of errors at the high voltage point;
set a low voltage point for the signals transmitted on the lane;
await a second predetermined amount of time; and
determine a number of errors at the low voltage point;
logic circuitry to determine a best equalization coefficient for the lane based on the jitter tolerance test and based on the voltage test; and
logic circuitry to provide the best equalization coefficient for the lane to a transmitting circuit element.

2. The receiving circuit element of claim 1, wherein the voltage logic circuitry to perform a voltage test comprises logic circuitry to:
determine that the number of errors at the high voltage point is less than a predetermined threshold error number;
determine that the number of errors at the low voltage point is less than the predetermined threshold error number; and
determine that the lane passes the voltage test based on the number of errors at the low voltage point and the number of errors at the high voltage point are less than the predetermined error number.

3. The receiving circuit element of claim 1, wherein the logic circuitry to determine a best equalization coefficient comprises logic circuitry to determine an equalization coefficient that has an error rate below a threshold value for a highest jitter tolerance value and a lowest voltage point.

4. The receiving circuit element of claim 1, wherein the jitter logic circuitry is to effect various jitter signals to induce varying levels of jitter on to the lane.

5. The receiving circuit element of claim 1, wherein the jitter signal aligns in phase with an intersymbol interference event in the at least one lane.

6. The receiving circuit element of claim 1, wherein the jitter induced by the device has a duty cycle of approximately 5 percent.

7. The receiving circuit element of claim 1, wherein the voltage logic circuitry is to set a high side voltage of 15 volts on the lane and a low side voltage of −15 volts on the lane.

8. The receiving circuit element of claim 1, wherein the voltage logic circuitry is to test a high and low voltage on the lane to cause the lane to fail.

9. A method at a receiving circuit element, the method comprising:
applying a transmission equalization coefficient to a lane of a communications link;
performing a jitter tolerance test on the lane of a communications link using the transmission equalization coefficient;
performing a voltage test on the lane of the communications link using the transmission equalization coefficient, wherein the performing the voltage test comprises:
setting a high voltage point for signals transmitted on the lane;
awaiting a first predetermined amount of time;
determining a number of errors at the high voltage point;
setting a low voltage point for the signals transmitted on the lane;
awaiting a second predetermined amount of time; and
determining a number of errors at the low voltage point;
determining a best equalization coefficient for the lane based on the jitter tolerance test and based on the voltage test; and
providing the best equalization coefficient for the lane to a transmitting circuit element.

10. The method of claim 9, further comprising:
determining that the number of errors at the high voltage point is less than a predetermined threshold error number;
determining that the number of errors at the low voltage point is less than the predetermined threshold error number; and
determining that the lane passes the voltage test based on the number of errors at the low voltage point and the number of errors at the high voltage point are less than the predetermined error number.

11. The receiving circuit element of claim 9, further comprising determining an equalization coefficient that has an error rate below a threshold value for a highest jitter tolerance value and a lowest voltage point.

12. The method of claim 9, wherein the jitter tolerance of the particular lane is determined by measuring the highest level of jitter the particular lane sustained prior to failing.

13. The method of claim 12, further comprising assigning a score for each measurement of the highest level of jitter for the particular lane per equalization coefficient.

14. The method of claim 12 further comprising assigning a score for each measurement of the highest level of jitter tolerance for each lane of the communication link per equalization coefficient.

15. The method of claim 12, wherein failing includes an inability to maintain a bit error rate threshold across the particular lane according to a communication protocol.

16. The method of claim 9, wherein a voltage margin of the particular lane is determined by measuring the highest voltage level for the particular lane sustained prior to failing and measuring the lowest voltage level for the particular lane sustained prior to failing.

17. The method of claim 9, wherein the plurality of equalization coefficients includes three equalization coefficients.

18. The method of claim 9, wherein the communication link is a Peripheral Component Interconnect Express (PCIe) bus interface link.

19. The method of claim 9, wherein using the particular equalization coefficient includes retraining the communication link to the particular equalization coefficient for the particular lane of the communication link.

20. The method of claim 9, wherein the communication link has at least 16 lanes.

21. A system, comprising:
a first component coupled to a second component wherein the first component and the second component are to communicate along a communication link; and
wherein the first and second components are to determine a particular equalization coefficient of a plurality of equalization coefficients that is to yield a maximum jitter tolerance for a particular lane in response to jitter induced on the particular lane and a minimum voltage margin in response to a voltage corners test induced on the particular lane, the voltage corners test comprising:
setting a high voltage point for signals transmitted on the lane;
awaiting a first predetermined amount of time;
determining a number of errors at the high voltage point;
setting a low voltage point for the signals transmitted on the lane;
awaiting a second predetermined amount of time; and
determining a number of errors at the low voltage point.

22. The system of claim 21, wherein the first component is a root complex device and the second component is an endpoint device.

23. The system of claim 21, wherein the second component includes a video card.

24. The system of claim 21, wherein the equalization coefficient is applied to the particular lane during an operational phase in response to determining the particular equalization coefficient that is to yield the maximum jitter tolerance for the particular lane and the minimum voltage margin for the particular lane.

25. The system of claim 21, wherein the plurality of equalization coefficients includes three transmitter equalization coefficients.
